(19) United States
(12) Patent Application Publication
(10) Pub. No.: US 2023/0009933 A1
(43) Pub. Date: Jan. 12, 2023

(54) CONFIGURATION FOR UPLINK REPETITIONS IN A RANDOM ACCESS PROCEDURE

(71) Applicant: Qualcomm Incorporated, San Diego, CA (US)

(72) Inventors: Qiaoyu LI, Beijing (CN); Jing LEI, San Diego, CA (US); Chao WEI, Beijing (CN)

(21) Appl. No.: 17/779,983

(22) PCT Filed: Dec. 17, 2019
(86) PCT No.: PCT/CN2019/125835

§ 371 Date: May 25, 2022

(51) Int. Cl. H04W 72/12; H04L 5/00; H04W 72/04; H04W 74/08; H04W 74/00

(52) U.S. Cl. CPC H04W 72/1268; H04L 5/0012; H04L 5/0044; H04W 72/0453; H04W 74/0833; H04W 74/002

(57) ABSTRACT

Methods, systems, and devices for wireless communications are described. In some systems, a user equipment (UE) may perform a random access channel (RACH) procedure with a base station. The UE may receive a message configuring a random access occasion and a PUSCH occasion. The UE may transmit a random access preamble according to the random access occasion scheduled in the message. The UE may also transmit a repetition of a physical uplink shared channel (PUSCH) data of the message corresponding to the random access occasion in each uplink transmission time interval for a defined number of uplink transmission time intervals that occur after the random access occasion.

### CROSS REFERENCE

The present application is a 371 national stage filing of International PCT Application No. PCT/CN2019/125835 by Li et al., entitled “CONFIGURATION FOR UPLINK REPETITIONS IN A RANDOM ACCESS PROCEDURE,” filed Dec. 17, 2019, which is assigned to the assignee hereof, and which is expressly incorporated by reference in its entirety herein.

### BACKGROUND

The following relates generally to wireless communications, and more specifically to random access occasion (RO) and physical uplink shared channel occasion (PO) configuration in a random access channel (RACH) procedure.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Some wireless communications systems may support one or more random access procedures (e.g., a UE may perform a random access procedure during initial access to establish a connection with the network). A random access procedure may involve a series of handshake messages exchanged between UEs and base stations using random access time and frequency resources. In some aspects, the random access procedures may be performed on a physical random access channel (PRACH) and may involve exchanging one or more random access channel (RACH) messages for establishing connectivity between a UE and a base station.

### SUMMARY

The described techniques relate to improved methods, systems, devices, and apparatuses that support configuration for uplink (UL) repetitions in a random access channel (RACH) procedure. Generally, the described techniques provide for improved random access procedures for user equipment (UEs). According to some aspects, UEs may be configured with a set of random access occasions (ROs), where each RO may be utilized by a UE for transmission of a random access (e.g., RACH) preamble of a first message (e.g., MsgA) in a two message random access procedure (e.g., a two-step RACH procedure) performed with a base station for establishing connectivity between the UE and base station. Further, each RO may be associated with physical uplink shared channel (PUSCH) data of the first message (e.g., MsgA) that may be transmitted by the UE in a PUSCH occasion (PO). In some cases, it may be beneficial for a UE to transmit the PUSCH data of the first message multiple times. Accordingly, repetitions of the PUSCH data may be transmitted subsequent to transmission by the UE of a random access preamble in a RO. In some cases, the repetitions of the PUSCH data may be transmitted in each uplink transmission time interval for a defined number of uplink transmission time intervals that occur after an associated RO. In reply, the UE may receive, from the base station, a second message of the two message random access procedure that may include information for establishing connectivity between the UE and base station.

A method of wireless communication by a UE is described. The method may include receiving a message configuring a resource allocation for a first message of a two message random access channel procedure (e.g., a two-step random access channel procedure including a Message-A transmission and a Message-B reception) that indicates at least a first random access occasion (RO) (e.g., for the Message-A transmission), transmitting, based on the message, a first random access preamble of the first message within the first RO, and transmitting a repetition of a first PUSCH data (e.g., Message-A transmission) of the first message corresponding to the first RO in each uplink transmission time interval for a defined number of uplink transmission time intervals that occur after the first RO.

An apparatus for wireless communication by a UE is described. The apparatus may include a processor, memory coupled with the processor, and instructions stored in the memory. The instructions may be executable by the processor to cause the apparatus to receive a message configuring a resource allocation for a first message of a two message random access channel procedure (e.g., a two-step random access channel procedure including a Message-A transmission and a Message-B reception) that indicates at least a first random access occasion (RO) (e.g., for the Message-A transmission), transmit, based on the message, a first random access preamble of the first message within the first RO, and transmit a repetition of a first PUSCH data (e.g., Message-A transmission) of the first message corresponding to the first RO in each uplink transmission time interval for a defined number of uplink transmission time intervals that occur after the first RO.

Another apparatus for wireless communication by a UE is described. The apparatus may include means for receiving a message configuring a resource allocation for a first message of a two message random access channel procedure (e.g., a two-step random access channel procedure including a Message-A transmission and a Message-B reception) that indicates at least a first random access occasion (RO) (e.g., for the Message-A transmission), transmitting, based on the message, a first random access preamble of the first message within the first RO, and transmitting a repetition of a first PUSCH data (e.g., Message-A transmission) of the first message corresponding to the first RO in each uplink transmission time interval for a defined number of uplink transmission time intervals that occur after the first RO.

A non-transitory computer-readable medium storing code for wireless communication by a UE is described. The code may include instructions executable by a processor to receive a message configuring a resource allocation for a first message of a two message random access channel procedure (e.g., a two-step random access channel procedure including a Message-A transmission and a Message-B reception) that indicates at least a first random access occasion (RO) (e.g., for the Message-A transmission), transmit, based on the message, a first random access preamble of the first message within the first RO, and transmit a repetition of a first PUSCH data (e.g., Message-A transmission) of the first message corresponding to the first RO in each uplink transmission time interval for a defined number of uplink transmission time intervals that occur after the first RO.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting each repetition of the first PUSCH data for the defined number of uplink transmission time intervals that may be consecutive uplink transmission time intervals.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting each repetition of the first PUSCH data within a same frequency resource.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting a respective repetition of the first PUSCH data in accordance with a frequency hopping pattern.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting each repetition of the first PUSCH data with one or more intervening downlink transmission time intervals, special subframe transmission time intervals, or both.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting a first repetition of the first PUSCH data at a frequency offset relative to a second repetition of the first PUSCH data based on a second RO and the first repetition being scheduled within a same uplink transmission time interval and having at least partially overlapping frequency resources.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting a first repetition of the first PUSCH data in an uplink transmission interval immediately following a last scheduled repetition of the first PUSCH data corresponding to the first random access preamble based on a second RO and the first repetition being scheduled within a same uplink transmission time interval and having at least partially overlapping frequency resources.

Some examples of the method, apparatuses, and non-transitory computer-readable medium described herein may further include operations, features, means, or instructions for transmitting each repetition of the first PUSCH data within a same frequency resource.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for canceling transmission of a first repetition of the first PUSCH data within an uplink transmission time interval based on a second RO and the first repetition being scheduled within the uplink transmission time interval and having at least partially overlapping frequency resources.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting a first repetition of the first PUSCH data at a frequency offset relative to a repetition of a second PUSCH data for the Message-A transmission corresponding to a second RO based on the first RO having a lower priority than the second RO; or, transmitting the repetition of the second PUSCH data corresponding to the second RO at a frequency offset relative to the first repetition of the first PUSCH data based on the second RO having a lower priority than the first RO, and where transmitting the first repetition of the first PUSCH data or the repetition of the second PUSCH data may be based on the first repetition of the first PUSCH data and the repetition of the second PUSCH data being scheduled within a same uplink transmission time interval and having at least partially overlapping frequency resources.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting a first repetition of the first PUSCH data in an uplink transmission interval immediately following a last scheduled repetition of the first PUSCH data corresponding to the first RO based on the first RO having a lower priority than a second RO; or, transmitting a repetition of a second PUSCH data for the Message-A transmission corresponding to the second RO in an uplink transmission interval immediately following a last scheduled repetition of the second PUSCH data corresponding to the second RO based on the second RO having a lower priority than the first RO, and where transmitting the first repetition of the first PUSCH data or the repetition of the second PUSCH data may be based on the first repetition of the first PUSCH data and the repetition of the second PUSCH data being scheduled within a same uplink transmission time interval and having at least partially overlapping frequency resources.

Some examples of the method, apparatuses, and non-transitory computer-readable medium described herein may further include operations, features, means, or instructions for transmitting the first repetition of the first PUSCH data within a same frequency resource as each first PUSCH data based on the first RO having a lower priority than the second RO; or, and transmitting the repetition of the second PUSCH data within a same frequency resource as each second PUSCH data based on the second RO having a lower priority than the first RO.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for canceling transmission of a first repetition of the first PUSCH data within an uplink transmission time interval based on the first RO having a lower priority than a second RO; or, canceling transmission of a repetition of a second PUSCH data for the Message-A transmission corresponding to the second RO within an uplink transmission time interval based on the second RO having a lower priority than the first RO, and where canceling transmission of the first repetition of the first PUSCH data or the repetition of the second PUSCH data may be based on the first repetition of the first PUSCH data and the repetition of the second PUSCH data being scheduled within a same uplink transmission time interval and having at least partially overlapping frequency resources.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting each repetition of the first PUSCH data at a frequency offset relative to each repetition of a second PUSCH data corresponding to a second RO based on the first RO having a lower priority than the second RO; or, transmitting each repetition of the second PUSCH data corresponding to the second RO at a frequency offset relative to each repetition of the first PUSCH data based on the second RO having a lower priority than the first RO, and where transmitting each repetition of the first PUSCH data or each repetition of the second PUSCH data may be based on.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting each repetition of the first PUSCH data in a set of uplink transmission intervals immediately following a last scheduled repetition of a second PUSCH data for the Message-A transmission corresponding to a second RO based on the first RO having a lower priority than the second RO; or, transmitting each repetition of the second PUSCH data corresponding to the second RO in a set of uplink transmission intervals immediately following a last scheduled repetition of the first PUSCH data corresponding to the first RO based on the second RO having a lower priority than the first RO, and where transmitting each repetition of the first PUSCH data or each repetition of the second PUSCH data may be based on the first RO and the second RO being time division multiplexed.

In some examples of the method, apparatuses, and non-transitory computer-readable medium described herein, transmitting the repetition of the first PUSCH data in each uplink transmission time interval for the defined number of uplink transmission time intervals may include operations, features, means, or instructions for transmitting in an alternating manner, each repetition of the first PUSCH data followed by each repetition of a second PUSCH data for the Message-A transmission corresponding to a second RO based on the first RO having a higher priority than the second RO; or, transmitting in an alternating manner, each repetition of the second PUSCH data followed by each repetition of the first PUSCH data based on the second RO having a higher priority than the first RO, and where transmitting each repetition of the first PUSCH data or each repetition of the second PUSCH data may be based on the first RO and the second RO being time division multiplexed.

In some examples of the method, apparatuses, and non-transitory computer-readable medium described herein, a mapping ratio for each repetition of the first PUSCH data may be based on a ratio between a number of valid Physical Uplink Shared Channel (PUSCH) resource unit sets and a number of valid random access preambles.

In some examples of the method, apparatuses, and non-transitory computer-readable medium described herein, the UE may be a New Radio Light UE including a lower complexity than other NR UEs.

In some examples of the method, apparatuses, and non-transitory computer-readable medium described herein, the repetition of the first PUSCH data may be a default UE capability for New Radio Light UEs.

A method of wireless communication by a base station is described. The method may include transmitting a message configuring a resource allocation for a first message of a two-step random access channel procedure (e.g., a two-step random access channel procedure including a Message-A reception and a Message-B transmission) that indicates at least a first random access occasion (RO) for the Message-A reception, receiving, based on the message, a first random access preamble of the first message within the first RO, and receiving a repetition of a first PUSCH data (e.g., Message-A reception) of the first message corresponding to the first RO in each uplink transmission time interval for a defined number of uplink transmission time intervals that occur after the first RO.

An apparatus for wireless communication by a base station is described. The apparatus may include a processor, memory coupled with the processor, and instructions stored in the memory. The instructions may be executable by the processor to cause the apparatus to transmit a message configuring a resource allocation for a first message of a two-step random access channel procedure (e.g., a two-step random access channel procedure including a Message-A reception and a Message-B transmission) that indicates at least a first random access occasion (RO) for the Message-A reception, receive, based on the message, a first random access preamble of the first message within the first RO, and receive a repetition of a first PUSCH data (e.g., Message-A reception) of the first message corresponding to the first RO in each uplink transmission time interval for a defined number of uplink transmission time intervals that occur after the first RO.

Another apparatus for wireless communication by a base station is described. The apparatus may include means for transmitting a message configuring a resource allocation for a first message of a two-step random access channel procedure (e.g., a two-step random access channel procedure including a Message-A reception and a Message-B transmission) that indicates at least a first random access occasion (RO) for the Message-A reception, receiving, based on the message, a first random access preamble of the first message within the first RO, and receiving a repetition of a first PUSCH data (e.g., Message-A reception) of the first message corresponding to the first RO in each uplink transmission time interval for a defined number of uplink transmission time intervals that occur after the first RO.

A non-transitory computer-readable medium storing code for wireless communication by a base station is described. The code may include instructions executable by a processor to transmit a message configuring a resource allocation for a first message of a two-step random access channel procedure (e.g., a two-step random access channel procedure including a Message-A reception and a Message-B transmission) that indicates at least a first random access occasion (RO) for the Message-A reception, receive, based on the message, a first random access preamble of the first message within the first RO, and receive a repetition of a first PUSCH data (e.g., Message-A reception) of the first message corresponding to the first RO in each uplink transmission time interval for a defined number of uplink transmission time intervals that occur after the first RO.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving each repetition of the first PUSCH data for the defined number of uplink transmission time intervals that may be consecutive uplink transmission time intervals.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving each repetition of the first PUSCH data within a same frequency resource.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving a respective repetition of the first PUSCH data in accordance with a frequency hopping pattern.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving each repetition of the first PUSCH data with one or more intervening downlink transmission time intervals, special subframe transmission time intervals, or both.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving a first repetition of the first PUSCH data at a frequency offset relative to a second repetition of the first PUSCH data based on a second RO and the first repetition being scheduled within a same uplink transmission time interval and having at least partially overlapping frequency resources.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving a first repetition of the first PUSCH data in an uplink transmission interval immediately following a last scheduled repetition of the first PUSCH data corresponding to the first RO based on a second RO and the first repetition being scheduled within a same uplink transmission time interval and having at least partially overlapping frequency resources.

Some examples of the method, apparatuses, and non-transitory computer-readable medium described herein may further include operations, features, means, or instructions for receiving each repetition of the first PUSCH data within a same frequency resource.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving a first repetition of the first PUSCH data at a frequency offset relative to a repetition of a second PUSCH data for the Message-A reception corresponding to a second RO based on the first RO having a lower priority than the second RO; or, receiving the repetition of the second PUSCH data corresponding to the second RO at a frequency offset relative to the first repetition of the first PUSCH data based on the second RO having a lower priority than the first RO, and where receiving the first repetition of the first PUSCH data or the repetition of the second PUSCH data may be based on the first repetition of the first PUSCH data and the repetition of the second PUSCH data being scheduled within a same uplink transmission time interval and having at least partially overlapping frequency resources.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving a first repetition of the first PUSCH data in an uplink transmission interval immediately following a last scheduled repetition of the first PUSCH data corresponding to the first RO based on the first RO having a lower priority than a second RO; or, receiving a repetition of a second PUSCH data for the Message-A reception corresponding to the second RO in an uplink transmission interval immediately following a last scheduled repetition of the second PUSCH data corresponding to the second RO based on the second RO having a lower priority than the first RO, and where receiving the first repetition of the first PUSCH data or the repetition of the second PUSCH data may be based on the first repetition of the first PUSCH data and the repetition of the second PUSCH data being scheduled within a same uplink transmission time interval and having at least partially overlapping frequency resources.

Some examples of the method, apparatuses, and non-transitory computer-readable medium described herein may further include operations, features, means, or instructions for receiving the first repetition of the first PUSCH data within a same frequency resource as each first PUSCH data based on the first RO having a lower priority than the second RO; or, and receiving the repetition of the second PUSCH data within a same frequency resource as each second PUSCH data based on the second RO having a lower priority than the first RO.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving each repetition of the first PUSCH data at a frequency offset relative to each repetition of a second PUSCH data for the Message-A reception corresponding to a second RO based on the first RO having a lower priority than the second RO; or, receiving each repetition of the second PUSCH data corresponding to the second RO at a frequency offset relative to each repetition of the first PUSCH data based on the second RO having a lower priority than the first RO, and where receiving each repetition of the first PUSCH data or each repetition of the second PUSCH data may be based on.

In some examples of the method, apparatuses, and non-transitory computer-readable medium described herein, the frequency offset may be configured by a requested minimum system information (RMSI) parameter or may be preconfigured.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving each repetition of the first PUSCH data in a set of uplink transmission intervals immediately following a last scheduled repetition of a second PUSCH data for the Message-A reception corresponding to a second RO based on the first RO having a lower priority than the second RO; or, receiving each repetition of the second PUSCH data corresponding to the second RO in a set of uplink transmission intervals immediately following a last scheduled repetition of the first PUSCH data corresponding to the first RO based on the second RO having a lower priority than the first RO, and where receiving each repetition of the first PUSCH data or each repetition of the second PUSCH data may be based on the first RO and the second RO being time division multiplexed.

In some examples of the method, apparatuses, and non-transitory computer-readable medium described herein, receiving the repetition of the first PUSCH data in each uplink transmission time interval for the defined number of uplink transmission time intervals may include operations, features, means, or instructions for receiving in an alternating manner, each repetition of the first PUSCH data followed by each repetition of a second PUSCH data for the Message-A reception corresponding to a second RO based on the first RO having a higher priority than the second RO; or, receiving in an alternating manner, each repetition of the second PUSCH data followed by each repetition of the first PUSCH data based on the second RO having a higher priority than the first RO, and where receiving each repetition of the first PUSCH data or each repetition of the second PUSCH data may be based on the first RO and the second RO being time division multiplexed.

In some examples of the method, apparatuses, and non-transitory computer-readable medium described herein, a mapping ratio for each repetition of the first PUSCH data may be based on a ratio between a number of valid Physical Uplink Shared Channel (PUSCH) resource unit sets and a number of valid random access preambles.

In some examples of the method, apparatuses, and non-transitory computer-readable medium described herein, the repetition of the first PUSCH data may be a default UE capability for New Radio Light UEs.

### BRIEF DESCRIPTION OF THE DRAWINGS

FIG. 1 illustrates an example of a system for wireless communications that supports configurations for uplink repetitions in a random access procedure in accordance with aspects of the present disclosure.

FIG. 2 illustrates an example of a wireless communications system that supports configurations for uplink repetitions in a random access procedure in accordance with aspects of the present disclosure.

FIGS. 3 through 9 illustrate examples of a frame structure that supports configurations for uplink repetitions in a random access procedure s in accordance with aspects of the present disclosure.

FIGS. 10 and 11 show block diagrams of devices that support configurations for uplink repetitions in a random access procedure in accordance with aspects of the present disclosure.

FIG. 12 shows a block diagram of a communications manager that supports configurations for uplink repetitions in a random access procedure in accordance with aspects of the present disclosure.

FIG. 13 shows a diagram of a system including a device that supports configurations for uplink repetitions in a random access procedure in accordance with aspects of the present disclosure.

FIGS. 14 and 15 show block diagrams of devices that support configurations for uplink repetitions in a random access procedure in accordance with aspects of the present disclosure.

FIG. 16 shows a block diagram of a communications manager that supports configurations for uplink repetitions in a random access procedure in accordance with aspects of the present disclosure.

FIG. 17 shows a diagram of a system including a device that supports configurations for uplink repetitions in a random access procedure in accordance with aspects of the present disclosure.

FIGS. 18 and 19 show flowcharts illustrating methods that support configurations for uplink repetitions in a random access procedure in accordance with aspects of the present disclosure.

### DETAILED DESCRIPTION

In some wireless communications systems, a high capability user equipment (UE) may perform a random access channel (RACH) procedure with a base station. A high capability UE may often determine whether to utilize a 2-step RACH or a 4-step RACH. If performing 2-step RACH, the UE may transmit a RACH preamble and a RACH payload, referred to as a RACH Message A (MsgA), before receiving a random access response (RAR) from the base station. If performing 4-step RACH, the UE may transmit the RACH preamble, referred to as a RACH Message 1 (Msg1), before receiving the RAR (e.g., in the first two steps of the 4-step RACH procedure). The UE may then transmit a RACH Message 3 (Msg3), which may be an example of an uplink data payload, and may receive a RACH Message 4 (Msg4) from the base station in response. The UE may use the RACH procedure to gain uplink synchronization with the base station and to obtain resources for transmitting a RACH payload, such as a radio resource control (RRC) connection request. Because a high capability UE has the ability to utilize multiple antennas, higher transmit/receive bandwidths, etc., a high capability UE may often utilize the 4-step RACH as it is often more robust than the 2-step RACH.

Some wireless communications systems may support New Radio (NR)-Light user equipments (UEs) (which may be referred to as Light devices, low tier devices, Internet of Things (IoT) devices, etc.). NR-Light UEs may include sensors (e.g., industrial sensors), cameras (e.g., video monitoring devices), wearable devices, IoT devices, low tier or relaxed devices, etc. Such NR-Light UEs may be used in a variety of applications, including healthcare, smart cities, transportation and logistics, electricity distribution, process automation, and building automation. NR-Light UEs may communicate with a base station and operate in the same cell as other, non-low complexity UEs (e.g., which may be referred to as regular UEs, high capability UEs, etc.).

However, NR-Light UEs may have reduced capabilities as compared to high capability UEs that may result in inefficient random access procedures. For example, NR-Light UEs may have a reduced transmission power (e.g., 10 dB less than a legacy eMBB UE) and transmit and receive bandwidth as compared to a higher capability UE (e.g., 5 MHz-20 MHz bandwidth for both Tx and Rx). NR-Light UEs may also have only one transmission and receive antenna as opposed multiple antennas of a higher capability UE. Only having one receive antenna may lead to an NR-Light UE having a lower equivalent receive signal-to-noise ratio as compared to a high capability UE. As such, NR-Light UEs may have difficulty or may be unable to successfully transmit and receive messages of random access procedures, which may result in network connection latency, poor network connections, increased configuration overhead, etc. In some cases, such a low complexity UE may be designed with such low complexity to maintain some intended benefit (e.g., such as reduced power consumption, reduced cost due to reduced Rx and/or Tx antenna equipment, reduced computational complexity, etc.).

As such, an NR-Light UE may perform random access channel (RACH) procedures (e.g., to establish a connection with a base station, to achieve uplink synchronization with the base station, etc.) that reflect its shortcomings. The RACH procedure may include a series of handshake messages carrying information that facilitates establishing the connection between the UE and the base station. The UE may use the RACH procedure to gain uplink synchronization with the base station and to obtain resources for transmitting a RACH payload (PUSCH data), such as a radio resource control (RRC) connection request. The RACH preamble may be transmitted using a random access occasion (RO) and the RACH payload may be transmitted using an uplink data occasion (e.g., a physical uplink shared channel (PUSCH) occasion (PO)). Because of an NR-Light device's lower transmission power and reduction in transmission antennas, repetition of POs may be utilized to compensate for coverage loss.

According to the techniques described herein, UEs with high or reduced capabilities (e.g., low complexity UEs, low tier UEs, NR-Light devices, Internet of Things (IoT) devices, etc.) may be jointly configured with ROs and PO repetitions. In some cases, the repetitions of the PUSCH data may be transmitted in each uplink transmission time interval for a defined number of uplink transmission time intervals that occur after an associated RO.

Aspects of the disclosure are initially described in the context of a wireless communications system. Additional aspects of the disclosure are described in the context of an additional wireless communications system and RACH communication schemes. Aspects of the disclosure are further illustrated by and described with reference to apparatus diagrams, system diagrams, and flowcharts that relate to RO and PO configuration in 2-step RACH with UL repetitions.

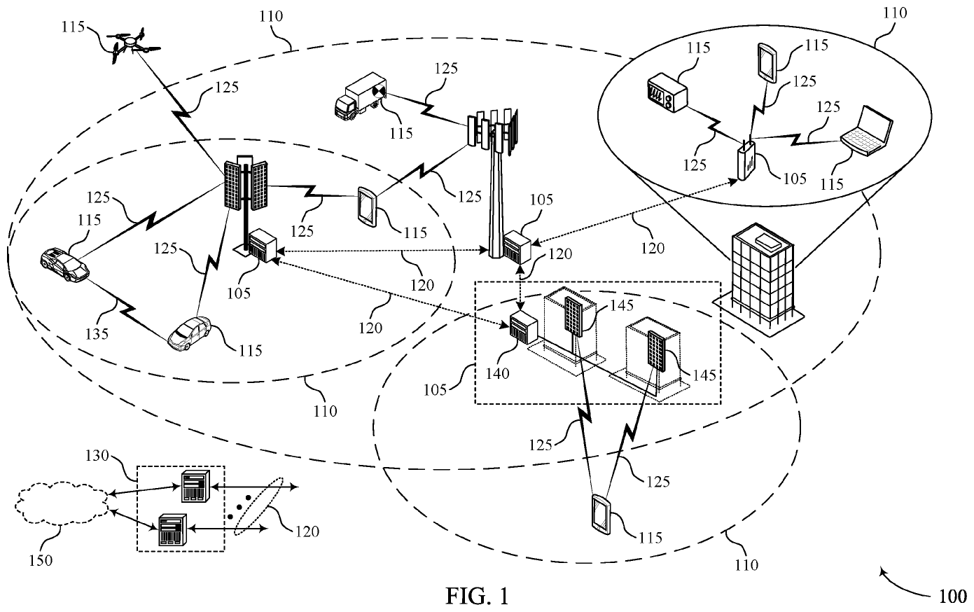

FIG. 1 illustrates an example of a wireless communications system 100 in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

Wireless devices operating in licensed or unlicensed spectrum within an NR network may participate in a two-step RACH procedure or a four-step RACH procedure to establish an initial connection or to re-establish a connection with a base station 105. A two-step RACH procedure may decrease the time it takes for the UE 115 and base station 105 to establish a connection as compared to a four-step RACH procedure. For example, when the UE 115 is performing LBT procedures in associations with the RACH procedure, the two-step RACH procedure may reduce delay in establishing a connection due to the decreased number of LBT procedures associated with the two-step process. In some cases, a four-step RACH procedure may increase the chances that the UE 115 is able to successfully establish a communication link 125 with the base station 105, for example if signal quality is poor.

Before a UE 115 may being a two-step RACH procedure, a UE 115 may receive information such as a synchronization signal block (SSB), a system information block (SIB), and reference signals in order to synchronize with base station 105 and measure any proposed communication channels. A two-step RACH procedure may include the UE 115 sending a first message (e.g., message A) to the base station 105. Message A may include information such as a preamble and UE identification. Additionally, message A may include a physical uplink shared channel (PUSCH) carrying data in a payload with the contents of the message where the preamble and payload may be transmitted on separate waveforms. In some cases, the base station 105 may transmit a downlink control channel (e.g., PDCCH) and a corresponding second RACH message (e.g., message B) to the UE 115 that includes information for establishing connectivity between the UE 115 and the base station 105. Such a two-step procedure may reduce signaling overhead and latency of communications between the base station 105 and UE 115 as compared to the four-step RACH process. In some cases, the two-step RACH procedure may be used when a UE 115 is sending a relatively small data transmission (e.g., mMTC).

However, in some cases, UEs 115 (e.g., including NR-Light UE 115) may be configured with reduced capabilities (e.g., compared to other high capability UEs 115 that may operate in same cell as an NR-Light UE 115) that may result in inefficient random access procedures. For example, a UE 115 may be configured to transmit with a reduced transmit power compared to other devices, may be equipped with a reduced number of receive antennas, may have reduced power consumption capacity, etc. For example, some UEs 115 may be equipped with a single receive antenna (e.g., which may result in a lower received SNR for a given signal compared to UEs 115 equipped with two receive antennas, four receive antennas, etc.). As such, UEs 115 may have difficulty or may be unable to successfully transmit uplink messages of random access procedures, which may result in network connection latency, poor network connections, etc.

According to the techniques described herein, UEs 115 may be jointly configured with ROs with a plurality of associated PUSCH data transmissions. In some cases, the repetitions of the PUSCH data may be transmitted in each uplink transmission time interval for a defined number of uplink transmission time intervals that occur after an associated RO.

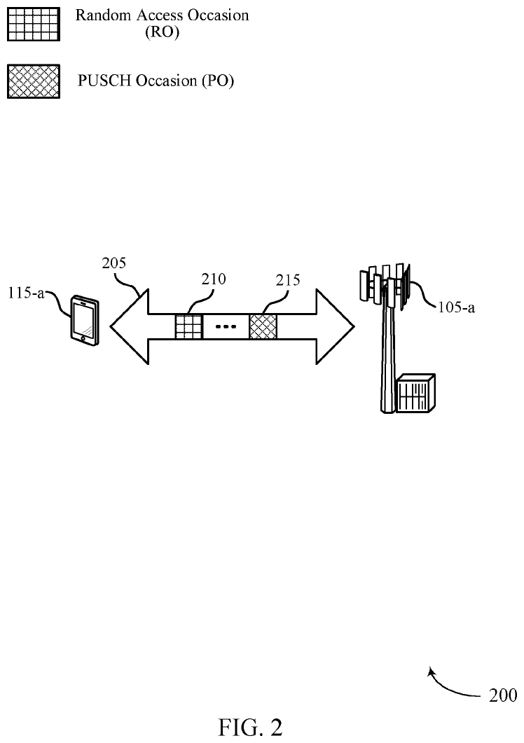

FIG. 2 illustrates an example of a wireless communications system 200 in accordance with aspects of the present disclosure. In some examples, wireless communications system 200 may implement aspects of wireless communication system 100. For instance, wireless communications system 200 may include a UE 115-a, which may be an example of a UE 115 or an NR-Light UE 115 as described with reference to FIG. 1, and a base station 105-a, which may be an example of a base station 105 as described with reference to FIG. 1. UE 115-a may communicate with base station 105-a over communication channel 205.

Before a UE 115 may being a two-step RACH procedure, a UE 115 may receive information such as a synchronization signal block (SSB), a system information block (SIB), and reference signals in order to synchronize with base station 105 and measure any proposed communication channels. UE 115-a may receive a resource allocation for a RACH procedure through RRC signaling. For example, base station 105-a may transmit a resource allocation to UE 115-a to configure one or more random access occasions 210 (which may be referred to as an RO) and one or more PUSCH occasions 215 (which may be referred to as a PO) for UE 115-a (although only one RO and one PO is shown, communication channel 205 may contain a plurality of each). RO 210 may include a time interval and frequency resource for transmitting a RACH preamble in a message A to base station 105-a, and PO 215 may include a time interval and frequency resource for transmitting PUSCH data in the message A to base station 105-a. RO 210 may include a guard time that precedes PO 215. The RACH preamble may include a message A RO index and a preamble sequence index. PO 215 may also include a guard time that follows the PUSCH data. PO 215 may include a demodulation reference signal (DMRS) index and a PUSCH occasion index. UE 115-a may select one or more DMRS resources and PUSCH occasions. Upon receiving a message A containing RO 210 and PO 215, a base station 105 may transmit to a UE 115 a message B which includes a physical downlink control channel (PDCCH) and a physical downlink shared channel (PDSCH). As described with reference to FIG. 1, because of an NR-Light device's lower transmission power and reduction in transmission antennas, repetition of PO 215 corresponding to RO 210 may be necessary to compensate for coverage loss.

In some cases, UE 115-a may perform a contention-based random access (CBRA) procedure. Performing CBRA may involve UE 115-a selecting among one or more RACH preambles and using the selected RACH preamble for message A. In some cases, the selection may be random. These one or more RACH preambles may be available for selection by other UEs 115, allowing for multiple UEs 115 to select the same RACH preamble. UEs 115 that perform a CBRA procedure may do so without first receiving a dedicated preamble from a base station 105.

In some cases, communication channel 205 may include a plurality of distinct ROs 210, with each RO 210 corresponding to a plurality of POs 215 (a transmission gap may exist between each RO 210 and PO 215). In this example, a first RO 210 may be initially scheduled to share at least a portion of a time and frequency resource with a second RO 210 or a PO 215. In other examples, a first RO 210 may be initially scheduled to share at least a portion of a time and frequency resource with a PO 215 associated with a second RO 210. In another example, a PO 215 associated with a first RO 210 may be initially scheduled to share at least a portion of a time and frequency resource with a PO 215 associated with a second RO 210. In each of these examples where multiple ROs 210 may be jointly scheduled to share communication channel 205 with multiple POs 215, NR-Light UE 115 may utilize various techniques in determining the scheduling of each RO 210 and PO 215.

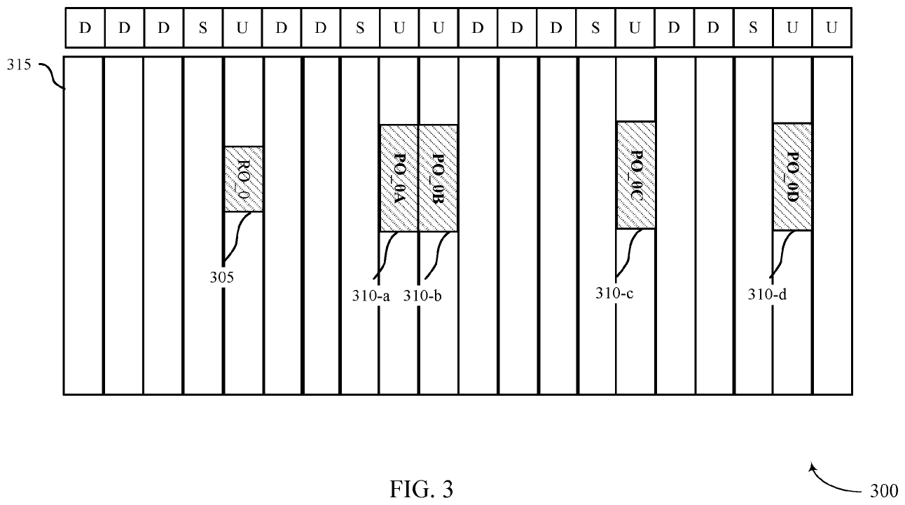

FIG. 3 illustrates an example of a frame structure 300 in accordance with aspects of the present disclosure. In some examples, frame structure 300 may implement aspects of wireless communication system 100. For example, frame structure 300 may represent a schedule that a base station 105 may use to jointly schedule ROs and POs over a communication channel for one or more UEs 115 to use for uplink transmission in a RACH procedure. In some cases, the base station 105 may transmit control signaling to configure the UE 115 with the frame structure 300. In some cases, an NR-Light UE 115 may utilize frame structure 300 in conjunction with a two-step RACH procedure.

Frame structure 300 may include subframes 315. Subframes 315 may be synchronized with each other and may have a time duration that may be referred to as a transmission time interval (TTI) each having an equal time duration. Additionally or alternatively, each subframe 315 of frame structure 300 may be one of a downlink subframe (denoted by a “D”), a special subframe (denoted by a “S”), or an uplink subframe (denoted by a “U”). Downlink subframes may carry downlink transmissions (e.g., physical downlink control channel (PDCCH) or a PDSCH); special subframes may carry reference signals (e.g., a sounding reference signal (SRS)) and/or control information; and uplink subframes may carry uplink transmissions (e.g., a RACH preamble, a physical uplink control channel (PUCCH), or physical uplink shared channel (PUSCH) data). In some cases, a fixed quantity of the subframes 315 (e.g., 10 subframes) may make up a frame. Subframes 315 may be arranged into a configuration that indicates a pattern of types of subframes (e.g., downlink, special, and uplink subframes), where the pattern repeats every frame (e.g., a TDD uplink-downlink configuration). In some examples, a frame may repeat every 5 ms. The base station 105 may transmit control signaling to the UE 115 that indicates the pattern.

Frame structure 300 may include RO 305 (labeled RO_0), and a plurality of POs 310 (labeled PO_0A, PO_0B, PO_0C, and PO_0D) corresponding to RO 305. In RO 305, a UE 115 may transmit a RACH preamble to a base station 105. In PO 310, a UE 115 may transmit PUSCH data to a base station 105. Each PO 310 may occur after RO 305. The base station 105 may transmit a control signaling (e.g., a message) to the UE 115 configuring a resource allocation for the RACH procedure that indicates a defined number of repetitions of a PO associated with a RO. For example, illustrated in FIG. 3, RO 305 is shown to be associated with four PO 310 repetitions. Each RO and PO may be defined through the resource allocation. Although four POs 310 corresponding to RO 305 are illustrated (indicating four repetitions of PUSCH data), more or less POs may correspond to a RO. The resource allocation may indicate one or transmission time intervals (e.g., slots) within a frame having a particular frame structure, as well as frequency resources (e.g., at least one frequency band, one or more resource blocks, etc.,) within the one or transmission time intervals, for at least one RO, at least one PO, or both. The same or other control signaling (e.g., message) may configure the UE 115 with any of the frame structures described herein.

In some examples, the UE 115 may transmit each repetition of PUSCH data within a same frequency resource, and the base station 105 may transmit control signaling that indicates the resource allocation to configure the UE 115 with the frequency resource. In some examples, the UE 115 may transmit each repetition of PUSCH data in accordance with a frequency hopping pattern, and the base station 105 may transmit control signaling that indicates the resource allocation to configure the UE 115 with the frequency hopping pattern.

In some cases, the UE 115 may transmit each repetition of the PUSCH data in each uplink subframe for a defined number of consecutive uplink transmission time intervals (e.g., consecutive uplink slots) that occur after their corresponding RO, and the base station 105 may transmit control signaling to configure the UE 115 with the defined number. For example, illustrated in FIG. 3, PO 310-a, PO 310-b, PO 310-c, and PO 310-d are each scheduled in a respective uplink transmission time interval after the uplink transmission time interval in which RO 305 is scheduled. In this example, the defined number of consecutive uplink transmission time intervals is four. In some examples, a mapping ratio for repetitions of PUSCH data can be defined as (# of valid PUSCH resource unit (PRU) sets/(# of valid RACH preambles). Here, each PRU set may include multiple repetitions of PUSCH for certain UEs (e.g., NR-Light UEs). In some cases, different msg A PUSCH configurations can associate with different mapping ratios. The mapping ratio can be signaled in a requested minimum system information (RMSI) parameter or a radio resource control (RRC) message. To support frequency hopping, virtual resource block to physical resource block mapping, or repetitions of PUSCH, a UE can select multiple PRUs which comprise multiple demodulation reference signal sequences/antenna ports and POs. In some examples, each repetition of PUSCH data is a default UE capability for New Radio Light UEs.

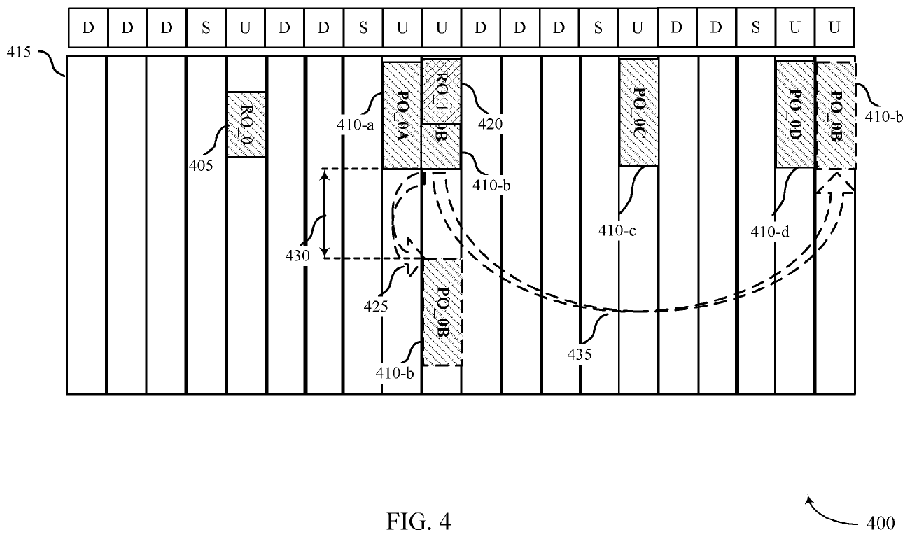

FIG. 4 illustrates an example of a frame structure 400 in accordance with aspects of the present disclosure. In some examples, frame structure 400 may implement aspects of wireless communication system 100. For example, frame structure 400 may represent a schedule base station 105 may use to jointly schedule ROs and POs over a communication channel for one or more UEs 115 to use for uplink transmission in a RACH procedure. In some cases, the base station 105 may transmit control signaling to configure the UE 115 with the frame structure 400. In some cases, an NR-Light UE 115 may utilize frame structure 400 in conjunction with a two-step RACH procedure.

Frame structure 400 may share features similar to those of frame structure 300. For example, it may include subframes 415 that may be one of a downlink subframe (“D”), a special subframe (“S”), or an uplink subframe (“U”). The downlink subframes, special subframes, and uplink subframes of frame structure 400 may include the same transmissions as those described with reference to frame structure 300.

Frame structure 400 may include RO 405 (labeled RO_0), and a plurality of POs 410 (labeled PO_0A, PO_0B, PO_0C, and PO_0D) corresponding to RO 405. In RO 405, a UE 115 may transmit a RACH preamble to a base station 105. In PO 410, a UE 115 may transmit PUSCH data to a base station 105. Each PO 410 may occur after RO 405. The allocated resources for the RACH procedure may indicate a defined number of repetitions of PUSCH data associated with a RO.

Additionally, frame structure 400 may include a second RO, RO 420 (labeled RO_1). Although not shown, RO 420 may correspond to one or more POs. In this example, RO 420 is scheduled with time and frequency resources that at least partially overlap time and frequency resources allocated to PO 410-b (partially obscured by RO 420). Under this scenario, PO 410-b may be rescheduled utilizing different techniques. For example, as shown by movement indicator 425, PO 410-b may be shifted in frequency within its original uplink time interval by a frequency offset 430. PO 410-b may be offset in frequency by a predetermined amount from its original frequency resource or it may be offset in frequency from an associated PO 410. Frequency offset 430 may be configured by a requested minimum system information (RMSI) parameter or it may be preconfigured.

In another example, as shown by movement indicator 435, PO 410-b may be shifted in time to an uplink time interval immediately following a last scheduled repetition of PO 410. In some cases, PO 410-b may be shifted in time to a first available uplink time interval following a last scheduled repetition of PO 410. In this example, PO 410-b may be shifted to a similar frequency resource as scheduled in its previous uplink time interval.

In some examples, although not shown, the transmission of PUSCH data associated with PO 410-b may be canceled due to its time and frequency resources overlapping with RO 420. It should be noted that although PO 410-b is provided in this example as at least partially overlapping its time and frequency resources with RO 420, any associated PO repetition may be rescheduled according to these techniques if they were to partially overlap time and frequency resources with RO 420.

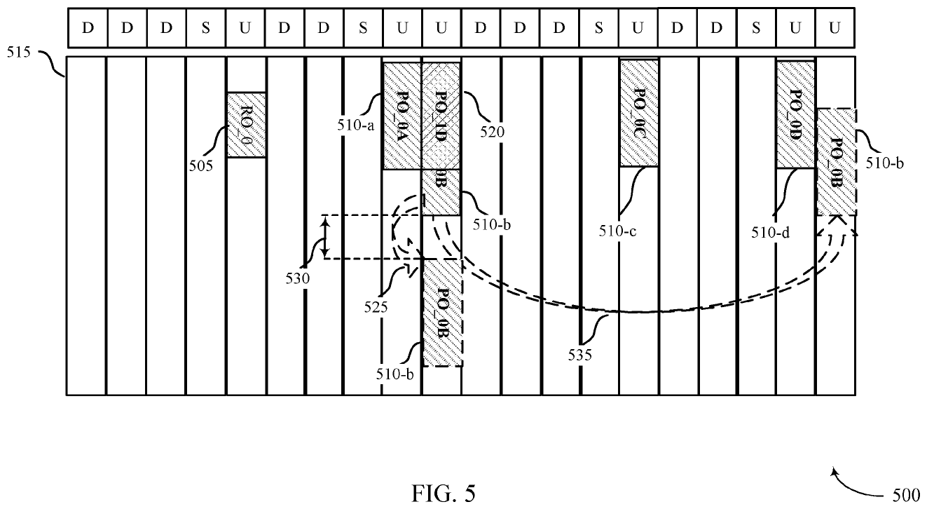

FIG. 5 illustrates an example of a frame structure 500 in accordance with aspects of the present disclosure. In some examples, frame structure 500 may implement aspects of wireless communication system 100. For example, frame structure 500 may represent a schedule base station 105 may use to jointly schedule ROs and POs over a communication channel for one or more UEs 115 to use for uplink transmission in a RACH procedure. In some cases, the base station 105 may transmit control signaling to configure the UE 115 with the frame structure 500. In some cases, an NR-Light UE 115 may utilize frame structure 500 in conjunction with a two-step RACH procedure.

Frame structure 500 may share features similar to those of frame structure 300. For example, it may include subframes 515 that may be one of a downlink subframe (“D”), a special subframe (“S”), or an uplink subframe (“U”). The downlink subframes, special subframes, and uplink subframes of frame structure 500 may include the same transmissions as those described with reference to frame structure 300.

Frame structure 500 may include RO 505 (labeled RO_0), and a plurality of POs 510 (labeled PO_0A, PO_0B, PO_0C, and PO_0D) corresponding to RO 505. In RO 505, a UE 115 may transmit a RACH preamble to a base station 105. In PO 510, a UE 115 may transmit PUSCH data to a base station 105. Each PO 510 may occur after RO 505. The allocated resources for the RACH procedure may indicate a defined number of repetitions of PUSCH data associated with a RO.

Additionally, frame structure 500 may include PO 520 (labeled PO_1D). PO 520 may correspond to a second RO (not shown), different than RO 505. In this example, PO 520 is scheduled with time and frequency resources that at least partially overlap time and frequency resources allocated to PO 510-b (partially obscured by PO 520). Under this scenario, PO 510-b or PO 520 may be rescheduled utilizing different techniques. First, a priority of PO 510-b is compared against PO 520. The priority between the two occasions may be determined from a comparison between a frequency range of RO 505 (associated with PO 510-b) to a frequency range of the RO associated with PO 520 (e.g., the RO that includes a higher or lower frequency range has a higher priority), a comparison between a timing of RO 505 to a timing of the RO associated with PO 520 (e.g., the RO that includes a an earlier or later time domain resource has a higher priority), a priority established in a requested minimum system information (RMSI) parameter, or a combination thereof.

Once a priority is established between PO 510-b and PO 520, one of them may be shifted to avoid overlapping time and/or frequency resources. For example, as shown by movement indicator 525, in the event PO 510-b has a lower priority than PO 520, PO 510-b may be shifted in frequency within its original uplink time interval by a frequency offset 530. PO 510-b may be offset in frequency by a predetermined amount from its original frequency resource or it may be offset in frequency from an associated PO 510. In the event that PO 520 has a lower priority than PO 510-b, PO may be shifted in frequency within its original uplink time interval by a frequency offset 530 (not shown). PO 520 may be offset in frequency by a predetermined amount from its original frequency resource or it may be offset in frequency from an associated PO (not shown). Frequency offset 530 may be configured by a requested minimum system information (RMSI) parameter or it may be preconfigured.

In another example, as shown by movement indicator 535, in the event PO 510-b has a lower priority than PO 520, PO 510-b may be shifted in time to an uplink time interval immediately following a last scheduled repetition of PO 510. In some cases, PO 510-b may be shifted in time to a first available uplink time interval following a last scheduled repetition of PO 510. In the event PO 520 has a lower priority than PO, PO 520 may be shifted in time to an uplink time interval immediately following a last scheduled repetition of its associated PO (not shown). In some cases, PO 520 may be shifted in time to a first available uplink time interval following a last scheduled repetition of its associated PO. In this example, the respective ROs may be shifted to a similar frequency resource as scheduled in its previous uplink time interval.

In some examples, although not shown, the transmission of PO 510-b may be canceled due to its time and frequency resources overlapping with PO 520. It should be noted that although PO 510-b is provided in this example as at least partially overlapping its time and frequency resources with PO 520, any associated PO repetition may be rescheduled according to these techniques if they were to partially overlap time and frequency resources with PO 520.

In some examples, although not shown, in the event PO 510-b has a lower priority than PO 520, the transmission of PO 510-b may be canceled due to its time and frequency resources overlapping with PO 520. In the event PO 520 has a lower priority than PO 510-b, the transmission of PO 520 may be canceled due to its time and frequency resources overlapping with PO 510-b. It should be noted that although PO 510-b is provided in this example as at least partially overlapping its time and frequency resources with PO 520, any associated PO repetition may be rescheduled according to these techniques if they were to partially overlap time and frequency resources with PO 520.

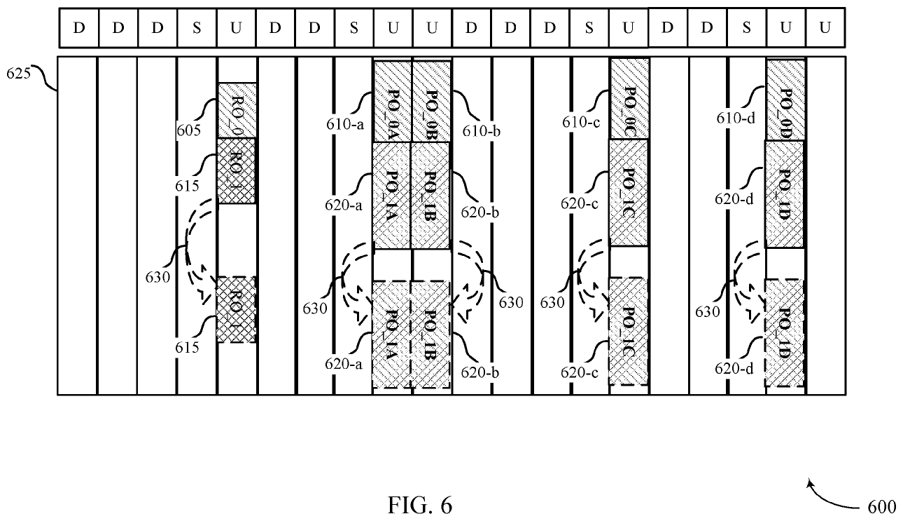

FIG. 6 illustrates an example of a frame structure 600 in accordance with aspects of the present disclosure. In some examples, frame structure 600 may implement aspects of wireless communication system 100. For example, frame structure 600 may represent a schedule base station 105 may use to jointly schedule ROs and POs over a communication channel for one or more UEs 115 to use for uplink transmission in a RACH procedure. In some cases, the base station 105 may transmit control signaling to configure the UE 115 with the frame structure 600. In some cases, an NR-Light UE 115 may utilize frame structure 600 in conjunction with a two-step RACH procedure.

Frame structure 600 may share features similar to those of frame structure 300. For example, it may include subframes 625 that may be one of a downlink subframe (“D”), a special subframe (“S”), or an uplink subframe (“U”). The downlink subframes, special subframes, and uplink subframes of frame structure 600 may include the same transmissions as those described with reference to frame structure 300.

Frame structure 600 may include RO 605 (labeled RO_0), and a plurality of POs 610 (labeled PO_0A, PO_0B, PO_0C, and PO_0D) corresponding to RO 605. Additionally, frame structure 600 may include RO 615 (labeled RO_1), and a plurality of POs 620 (labeled PO_1A, PO_1B, PO_1C, and PO_1D) corresponding to RO 615. In ROs 605 and 615, a UE 115 may transmit a RACH preamble to a base station 105. In POs 610 and 620, a UE 115 may transmit PUSCH data to a base station 105. Each PO may occur after its corresponding RO. The allocated resources for the RACH procedure may indicate a defined number of repetitions of PUSCH data associated with a RO.

In this example, RO 605 and RO 615 are frequency division multiplexed with each other. Accordingly, repetitions of PO 610 associated with RO 605 are frequency division multiplexed with repetitions of PO 620 associated with RO 615. In some cases, RO 605 is scheduled with time and frequency resources that at least partially overlap time and frequency resources allocated to RO 615. Also, the repetitions of PO 610 associated with RO 605 are scheduled with time and frequency resources that at least partially overlap time and frequency resources allocated to repetitions of PO 620 associated with RO 615. Under this scenario, the overlapping occasions may be rescheduled utilizing different techniques. First, a priority of RO 605 is compared against RO 615. The priority between the two occasions may be determined from a comparison between a frequency range of RO 605 to a frequency range of the RO 615, a comparison between a timing of RO 605 to a timing of the RO 615, a priority established in a requested minimum system information (RMSI) parameter, or a combination thereof.

Once a priority is established between RO 605 and RO 615, one of them may be shifted to avoid overlapping time and/or frequency resources. For example, as shown by movement indicator 630, in the event RO 615 has a lower priority than RO 605, RO 615 may be shifted in frequency within its original uplink time interval such that RO 615 no longer overlaps in frequency with RO 605. Accordingly, as shown by movement indicator 630, the repetitions of PO 620 corresponding to RO 615 are shifted in frequency within their respective original uplink time intervals such that they no longer overlap in frequency with repetitions of PO 610. In the event that RO 605 has a lower priority than RO 615, RO 605 may be shifted in frequency within its original uplink time interval such that RO 605 no longer overlaps in frequency with RO 615 (not shown). Additionally, the repetitions of PO 610 corresponding to RO 605 are shifted in frequency within their respective original uplink time intervals such that they no longer overlap in frequency with repetitions of PO 620. The frequency offset may be configured by a requested minimum system information (RMSI) parameter or it may be preconfigured.

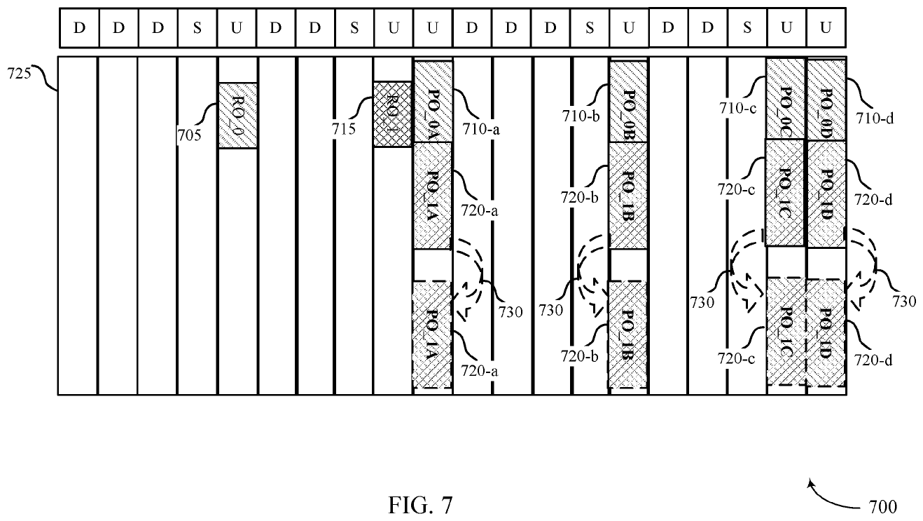

FIG. 7 illustrates an example of a frame structure 700 in accordance with aspects of the present disclosure. In some examples, frame structure 700 may implement aspects of wireless communication system 100. For example, frame structure 700 may represent a schedule base station 105 may use to jointly schedule ROs and POs over a communication channel for one or more UEs 115 to use for uplink transmission. In some cases, the base station 105 may transmit control signaling to configure the UE 115 with the frame structure 700. In some cases, an NR-Light UE 115 may utilize frame structure 700 in conjunction with a two-step RACH procedure.

Frame structure 700 may share features similar to those of frame structure 300. For example, it may include subframes 725 that may be one of a downlink subframe (“D”), a special subframe (“S”), or an uplink subframe (“U”). The downlink subframes, special subframes, and uplink subframes of frame structure 700 may include the same transmissions as those described with reference to frame structure 300.

Frame structure 700 may include RO 705 (labeled RO_0), and a plurality of POs 710 (labeled PO_0A, PO_0B, PO_0C, and PO_0D) corresponding to RO 705. Additionally, frame structure 700 may include RO 715 (labeled RO_1), and a plurality of POs 720 (labeled PO_1A, PO_1B, PO_1C, and PO_1D) corresponding to RO 715. In ROs 705 and 715, a UE 115 may transmit a RACH preamble to a base station 105. In POs 710 and 720, a UE 115 may transmit PUSCH data to a base station 105. Each PO may occur after its corresponding RO. The allocated resources for the RACH procedure may indicate a defined number of repetitions of PUSCH data associated with a RO.

In this example, RO 705 is time division multiplexed with RO 715. RO 705 and RO 715 may be scheduled in adjoining uplink time intervals. Additionally, the repetitions of PO 710 associated with RO 705 are scheduled with time and frequency resources that at least partially overlap time and frequency resources allocated to repetitions of PO 720 associated with RO 715. Under this scenario, the overlapping occasions may be rescheduled utilizing different techniques. First, a priority of RO 705 is compared against RO 715. The priority between the two occasions may be determined from a comparison between a frequency range of RO 705 to a frequency range of the RO 715, a comparison between a timing of RO 705 to a timing of the RO 715, a priority established in a requested minimum system information (RMSI) parameter, or a combination thereof.

Once a priority is established between RO 705 and RO 715, corresponding POs 710 or 720, respectively, may be shifted to avoid overlapping time and/or frequency resources. For example, in the event RO 715 has a lower priority than RO 705, as shown by movement indicator 730, the repetitions of PO 720 corresponding to RO 715 are shifted in frequency within their respective original uplink time intervals such that they no longer overlap in frequency with repetitions of PO 710. In the event that RO 705 has a lower priority than RO 715, the repetitions of PO 710 corresponding to RO 705 are shifted in frequency within their respective original uplink time intervals such that they no longer overlap in frequency with repetitions of PO 720 (not shown). The frequency offset may be configured by a requested minimum system information (RMSI) parameter or it may be preconfigured.

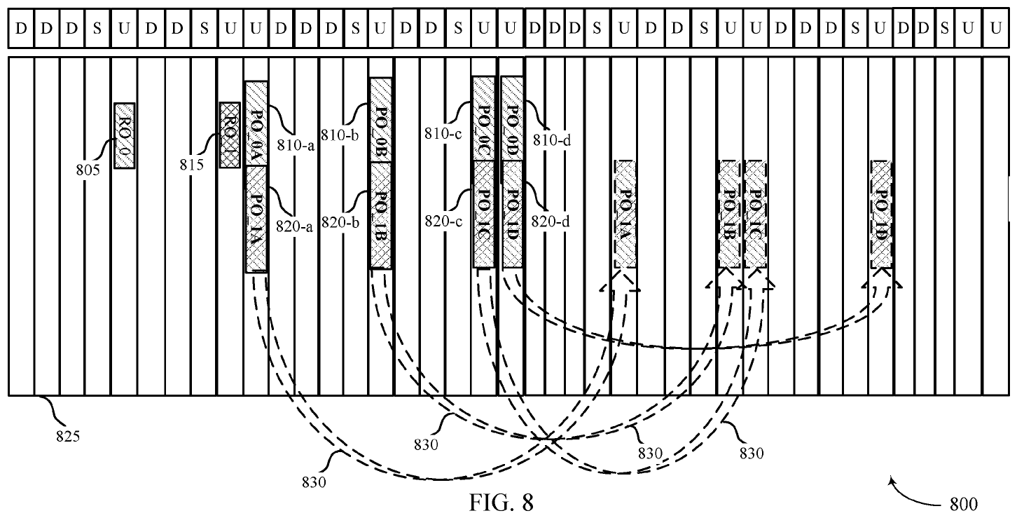

FIG. 8 illustrates an example of a frame structure 800 in accordance with aspects of the present disclosure. In some examples, frame structure 800 may implement aspects of wireless communication system 100. For example, frame structure 800 may represent a schedule base station 105 may use to jointly schedule ROs and POs over a communication channel for one or more UEs 115 to use for uplink transmission in a RACH procedure. In some cases, the base station 105 may transmit control signaling to configure the UE 115 with the frame structure 300. In some cases, an NR-Light UE 115 may utilize frame structure 800 in conjunction with a two-step RACH procedure.

Frame structure 800 may share features similar to those of frame structure 300. For example, it may include subframes 825 that may be one of a downlink subframe (“D”), a special subframe (“S”), or an uplink subframe (“U”). The downlink subframes, special subframes, and uplink subframes of frame structure 800 may include the same transmissions as those described with reference to frame structure 300.

Frame structure 800 may include RO 805 (labeled RO_0), and a plurality of POs 810 (labeled PO_0A, PO_0B, PO_0C, and PO_0D) corresponding to RO 805. Additionally, frame structure 800 may include RO 815 (labeled RO_1), and a plurality of POs 820 (labeled PO_1A, PO_1B, PO_1C, and PO_1D) corresponding to RO 815. In ROs 805 and 815, a UE 115 may transmit a RACH preamble to a base station 105. In POs 810 and 820, a UE 115 may transmit PUSCH data to a base station 105. Each PO may occur after its corresponding RO. The allocated resources for the RACH procedure may indicate a defined number of repetitions of PUSCH data associated with a RO.

In this example, RO 805 is time division multiplexed with RO 815. RO 805 and RO 815 may be scheduled in adjoining uplink time intervals. Additionally, the repetitions of PO 810 associated with RO 805 are scheduled with time and frequency resources that at least partially overlap time and frequency resources allocated to repetitions of PO 820 associated with RO 815. Under this scenario, the overlapping occasions may be rescheduled utilizing different techniques. First, a priority of RO 805 is compared against RO 815. The priority between the two occasions may be determined from a comparison between a frequency range of RO 805 to a frequency range of the RO 815, a comparison between a timing of RO 805 to a timing of the RO 815, a priority established in a requested minimum system information (RMSI) parameter, or a combination thereof.

Once a priority is established between RO 805 and RO 815, corresponding POs 810 or 820, respectively, may be shifted to avoid overlapping time and/or frequency resources. For example, in the event RO 815 has a lower priority than RO 805, as shown by movement indicators 830, the repetitions of PO 820 corresponding to RO 815 are shifted in time such that the repetitions of PO 820 each follow a last scheduled repetition of PO 810. In other words, PO 820-a, PO 820-b, PO 820-c, and PO 820-d will each be scheduled in respective uplink subframes after the last scheduled repetition of PO 810, which is PO 810-d.

In the event RO 805 has a lower priority than RO 815, the repetitions of PO 810 corresponding to RO 805 are shifted in time such that the repetitions of PO 810 each follow a last scheduled repetition of PO 820. In other words, PO 810-a, PO 810-b, PO 810-c, and PO 810-d will each be scheduled in respective uplink subframes after the last scheduled repetition of PO 820, which is PO 820-d (not shown).

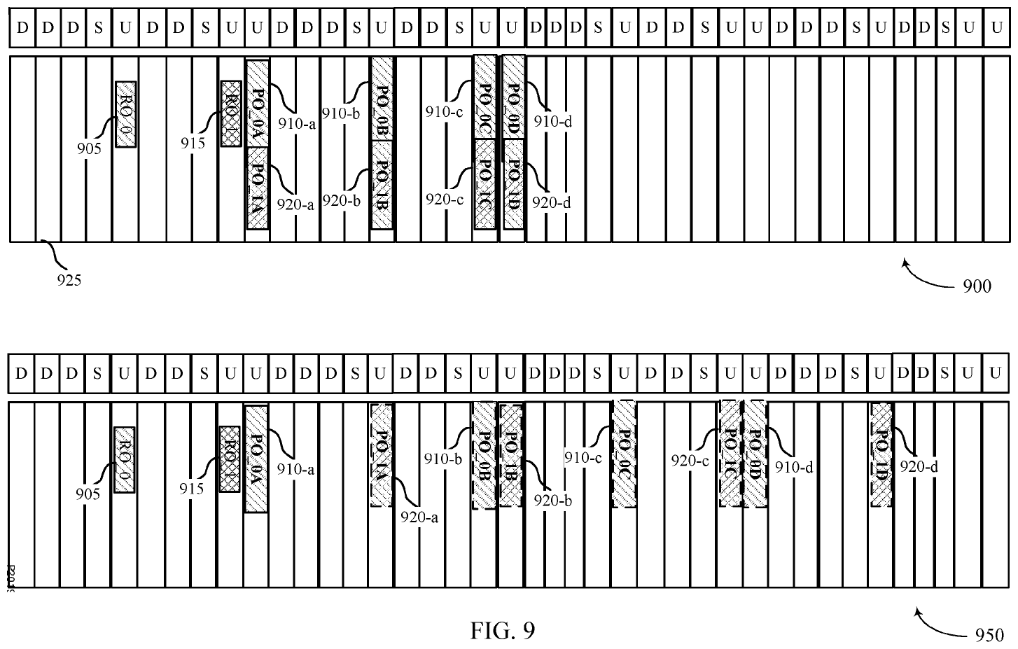

FIG. 9 illustrates an example of a frame structures 900 and 950 in accordance with aspects of the present disclosure. In some examples, frame structures 900 and 950 may implement aspects of wireless communication system 100. For example, frame structures 900 and 950 may represent a schedule base station 105 may use to jointly schedule ROs and POs over a communication channel for one or more UEs 115 to use for uplink transmission in a RACH procedure. In some cases, the base station 105 may transmit control signaling to configure the UE 115 with the frame structure 300. In some cases, an NR-Light UE 115 may utilize frame structure 900 in conjunction with a two-step RACH procedure.

Frame structures 900 and 950 may share features similar to those of frame structure 300. For example, it may include subframes 925 that may be one of a downlink subframe (“D”), a special subframe (“S”), or an uplink subframe (“U”). The downlink subframes, special subframes, and uplink subframes of frame structures 900 and 950 may include the same transmissions as those described with reference to frame structure 300.

Frame structures 900 and 950 may include RO 905 (labeled RO_0), and a plurality of POs 910 (labeled PO_0A, PO_0B, PO_0C, and PO_0D) corresponding to RO 905. Additionally, frame structures 900 and 950 may include RO 915 (labeled RO_1), and a plurality of POs 920 (labeled PO_1A, PO_1B, PO_1C, and PO_1D) corresponding to RO 915. In ROs 905 and 915, a UE 115 may transmit a RACH preamble to a base station 105. In POs 910 and 920, a UE 115 may transmit PUSCH data to a base station 105. Each PO may occur after its corresponding RO. The allocated resources for the RACH procedure may indicate a defined number of repetitions of PUSCH data associated with a RO.

Beginning with frame structure 900, RO 905 is time division multiplexed with RO 915. RO 905 and RO 915 may be scheduled in adjoining uplink time intervals. Additionally, the repetitions of PO 910 associated with RO 905 are scheduled with time and frequency resources that at least partially overlap time and frequency resources allocated to repetitions of PO 920 associated with RO 915. Under this scenario, the overlapping occasions may be rescheduled utilizing different techniques. First, a priority of RO 905 is compared against RO 915. The priority between the two occasions may be determined from a comparison between a frequency range of RO 905 to a frequency range of the RO 915, a comparison between a timing of RO 905 to a timing of the RO 915, a priority established in a requested minimum system information (RMSI) parameter, or a combination thereof.

Once a priority is established between RO 905 and RO 915, corresponding POs 910 or 920, respectively, may be shifted to avoid overlapping time and/or frequency resources. Frame structure 950 illustrates how POs 910 and 920 are shifted relative to their positions in frame structure 900. For example, in the event RO 915 has a lower priority than RO 905, PO 910-a (associated with RO 905) is scheduled in an uplink subframe following the uplink subframe that RO 915 is scheduled in. Then PO 920-a (associated with RO 915) is scheduled in an uplink subframe following the uplink subframe that PO 910-a is scheduled in. The remaining respective ROs of 910 and 920 then are scheduled in alternating uplink subframes following the uplink subframe that PO 920-a is scheduled in until no ROs remain. In other words, following RO 915, the order that POs 910 and 920 are scheduled are as follows: PO 910-a, PO 920-a, PO 910-b, PO 920-b, PO 910-c, PO 920-c, PO 910-d, and PO 920-d.

In the event RO 905 has a lower priority than RO 915, PO 920-a (associated with RO 915) is scheduled in an uplink subframe following the uplink subframe that RO 915 is scheduled in. Then PO 910-a (associated with RO 905) is scheduled in an uplink subframe following the uplink subframe that PO 920-a is scheduled in. The remaining respective ROs of 910 and 920 then are scheduled in alternating uplink subframes following the uplink subframe that PO 910-a is scheduled in until no ROs remain. In other words, following RO 915, the order that POs 910 and 920 are scheduled are as follows: PO 920-a, PO 910-a, PO 920-b, PO 910-b, PO 920-c, PO 910-c, PO 920-d, and PO 910-d (not shown).

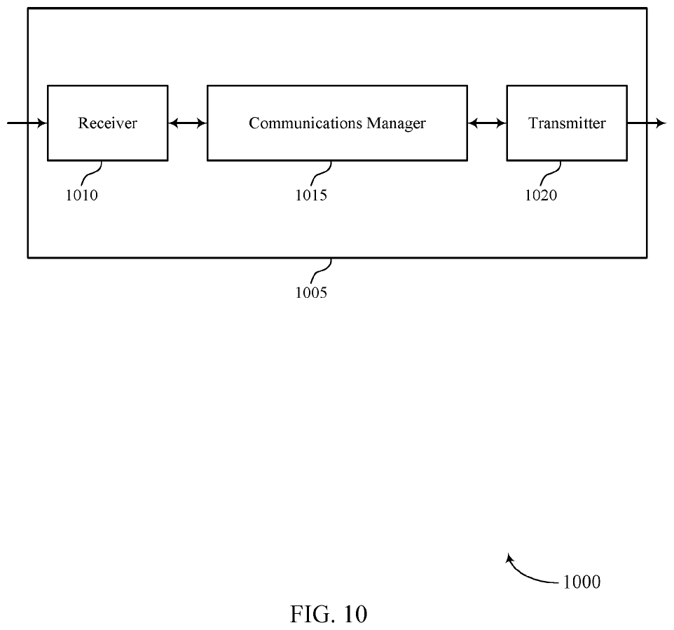

FIG. 10 shows a block diagram 1000 of a device 1005 in accordance with aspects of the present disclosure. The device 1005 may be an example of aspects of a UE 115 as described herein. The device 1005 may include a receiver 1010, a communications manager 1015, and a transmitter 1020. The device 1005 may also include a processor. Each of these components may be in communication with one another (e.g., via one or more buses).

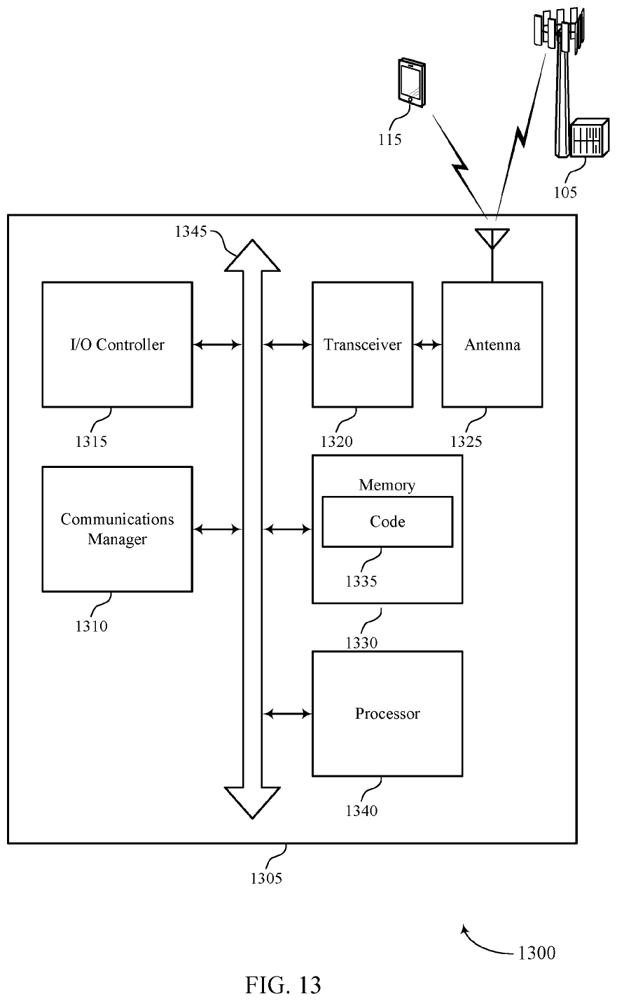

The receiver 1010 may receive information such as packets, user data, or control information associated with various information channels (e.g., control channels, data channels, and information related to RO and PO configuration in 2-step RACH with UL repetitions, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may receive a message configuring a resource allocation for a first message of a two message random access channel procedure that indicates at least a first random access occasion (RO), transmit, based on the message, a first random access preamble of the first message within the first RO, and transmit a repetition of a first PUSCH data of the first message corresponding to the first RO in each uplink transmission time interval for a defined number of uplink transmission time intervals that occur after the first RO. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The actions performed by the UE communications manager 1015 as described herein may be implemented to realize one or more potential advantages. One implementation may provide improved quality and reliability of service at the UE 115, as latency and the number of separate resources allocated to the UE 115 may be reduced.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

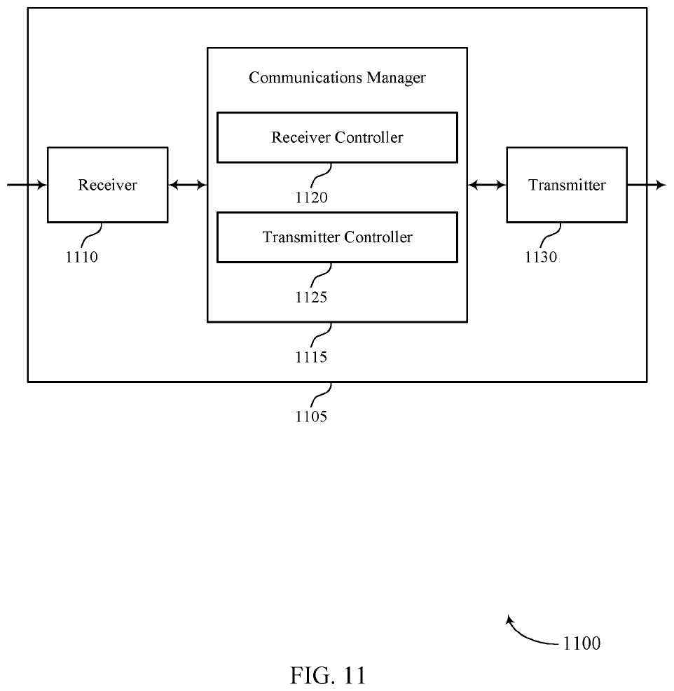

FIG. 11 shows a block diagram 1100 of a device 1105 in accordance with aspects of the present disclosure. The device 1105 may be an example of aspects of a device 1005, or a UE 115 as described herein. The device 1105 may include a receiver 1110, a communications manager 1115, and a transmitter 1130. The device 1105 may also include a processor. Each of these components may be in communication with one another (e.g., via one or more buses).

The receiver 1110 may receive information such as packets, user data, or control information associated with various information channels (e.g., control channels, data channels, and information related to RO and PO configuration in 2-step RACH with UL repetitions, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a receiver controller 1120 and a transmitter controller 1125. The communications manager 1115 may be an example of aspects of the communications manager 1310 described herein.

The receiver controller 1120 may receive a message configuring a resource allocation for a first message of a two message random access channel procedure that indicates at least a first random access occasion (RO).

The transmitter controller 1125 may transmit, based on the message, a first random access preamble of the first message within the first RO and transmit a repetition of a first PUSCH data of the first message corresponding to the first RO in each uplink transmission time interval for a defined number of uplink transmission time intervals that occur after the first RO.

The transmitter 1130 may transmit signals generated by other components of the device 1105. In some examples, the transmitter 1130 may be collocated with a receiver 1110 in a transceiver module. For example, the transmitter 1130 may be an example of aspects of the transceiver 1320 described with reference to FIG. 13. The transmitter 1130 may utilize a single antenna or a set of antennas.

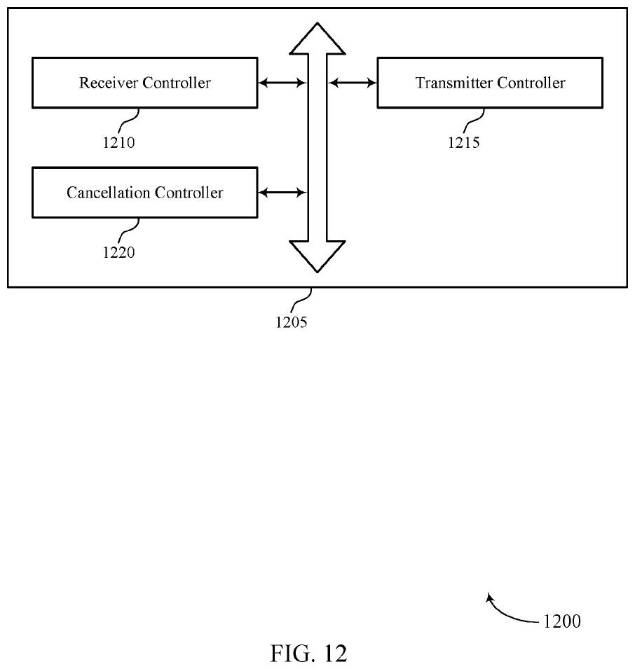

FIG. 12 shows a block diagram 1200 of a communications manager 1205 in accordance with aspects of the present disclosure. The communications manager 1205 may be an example of aspects of a communications manager 1015, a communications manager 1115, or a communications manager 1310 described herein. The communications manager 1205 may include a receiver controller 1210, a transmitter controller 1215, and a cancellation controller 1220. Each of these modules may communicate, directly or indirectly, with one another (e.g., via one or more buses).

The receiver controller 1210 may receive a message configuring a resource allocation for a first message of a two message random access channel procedure that indicates at least a first random access occasion (RO).

In some examples, the receiver controller 1210 may receive a second message to establish a wireless communications connection with a base station, where the first message is a message A of the two message RACH procedure and the second message is a message B of the two message RACH procedure.

The transmitter controller 1215 may transmit, based on the message, a first random access preamble of the first message within the first RO.

In some examples, the transmitter controller 1215 may transmit a repetition of a first PUSCH data of the first message corresponding to the first RO in each uplink transmission time interval for a defined number of uplink transmission time intervals that occur after the first RO.

In some examples, the transmitter controller 1215 may transmit each repetition of the first PUSCH data for the defined number of uplink transmission time intervals that are consecutive uplink transmission time intervals. In some examples, the transmitter controller 1215 may transmit each repetition of the first PUSCH data within a same frequency resource. In some examples, the transmitter controller 1215 may transmit a respective repetition of the first PUSCH data in accordance with a frequency hopping pattern. In some examples, the transmitter controller 1215 may transmit each repetition of the first PUSCH data with one or more intervening downlink transmission time intervals, special subframe transmission time intervals, or both.

In some examples, the transmitter controller 1215 may transmit a first repetition of the first PUSCH data at a frequency offset relative to a second repetition of the first PUSCH data based on a second RO and the first repetition being scheduled within a same uplink transmission time interval and having at least partially overlapping frequency resources.

In some examples, the transmitter controller 1215 may transmit a first repetition of the first PUSCH data in an uplink transmission interval immediately following a last scheduled repetition of the first PUSCH data corresponding to the first random access preamble based on a second RO and the first repetition being scheduled within a same uplink transmission time interval and having at least partially overlapping frequency resources.

In some examples, the transmitter controller 1215 may transmit a first repetition of the first PUSCH data at a frequency offset relative to a repetition of a second PUSCH data corresponding to a second RO based on the first RO having a lower priority than the second RO; or.

In some examples, the transmitter controller 1215 may transmit the repetition of the second PUSCH data corresponding to the second RO at a frequency offset relative to the first repetition of the first PUSCH data based on the second RO having a lower priority than the first RO.

In some examples, the transmitter controller 1215 may transmit a first repetition of the first PUSCH data in an uplink transmission interval immediately following a last scheduled repetition of the first PUSCH data corresponding to the first RO based on the first RO having a lower priority than a second RO; or.

In some examples, the transmitter controller 1215 may transmit a repetition of a second PUSCH data corresponding to the second RO in an uplink transmission interval immediately following a last scheduled repetition of the second PUSCH data corresponding to the second RO based on the second RO having a lower priority than the first RO.

In some examples, the transmitter controller 1215 may transmit the first repetition of the first PUSCH data within a same frequency resource as each first PUSCH data based on the first RO having a lower priority than the second RO; or.

In some examples, the transmitter controller 1215 may transmit the repetition of the second PUSCH data within a same frequency resource as each second PUSCH data based on the second RO having a lower priority than the first RO.

In some examples, the transmitter controller 1215 may transmit each repetition of the first PUSCH data at a frequency offset relative to each repetition of a second PUSCH data corresponding to a second RO based on the first RO having a lower priority than the second RO; or.

In some examples, the transmitter controller 1215 may transmit each repetition of the second PUSCH data corresponding to the second RO at a frequency offset relative to each repetition of the first PUSCH data based on the second RO having a lower priority than the first RO.

In some examples, the transmitter controller 1215 may transmit each repetition of the first PUSCH data in a set of uplink transmission intervals immediately following a last scheduled repetition of a second PUSCH data corresponding to a second RO based on the first RO having a lower priority than the second RO; or.

In some examples, the transmitter controller 1215 may transmit each repetition of the second PUSCH data corresponding to the second RO in a set of uplink transmission intervals immediately following a last scheduled repetition of the first PUSCH data corresponding to the first RO based on the second RO having a lower priority than the first RO.

In some examples, the transmitter controller 1215 may transmit in an alternating manner, each repetition of the first PUSCH data followed by each repetition of a second PUSCH data corresponding to a second RO based on the first RO having a higher priority than the second RO; or.

In some examples, the transmitter controller 1215 may transmit in an alternating manner, each repetition of the second PUSCH data followed by each repetition of the first PUSCH data based on the second RO having a higher priority than the first RO.

The cancellation controller 1220 may cancel transmission of a first repetition of the first PUSCH data within an uplink transmission time interval based on a second RO and the first repetition being scheduled within the uplink transmission time interval and having at least partially overlapping frequency resources.

In some examples, the cancellation controller 1220 may cancel transmission of a first repetition of the first PUSCH data within an uplink transmission time interval based on the first RO having a lower priority than a second RO; or.

In some examples, the cancellation controller 1220 may cancel transmission of a repetition of a second PUSCH data corresponding to the second RO within an uplink transmission time interval based on the second random access preamble having a lower priority than the first RO.

FIG. 13 shows a diagram of a system 1300 including a device 1305 in accordance with aspects of the present disclosure. The device 1305 may be an example of or include the components of device 1005, device 1105, or a UE 115 as described herein. The device 1305 may include components for bi-directional voice and data communications including components for transmitting and receiving communications, including a communications manager 1310, an I/O controller 1315, a transceiver 1320, an antenna 1325, memory 1330, and a processor 1340. These components may be in electronic communication via one or more buses (e.g., bus 1345).

The communications manager 1310 may receive a message configuring a resource allocation for a first message of a two message random access channel procedure that indicates at least a first random access occasion (RO), transmit, based on the message, a first random access preamble of the first message within the first RO, and transmit a repetition of a first PUSCH data of the first message corresponding to the first RO in each uplink transmission time interval for a defined number of uplink transmission time intervals that occur after the first RO.

The I/O controller 1315 may manage input and output signals for the device 1305. The I/O controller 1315 may also manage peripherals not integrated into the device 1305. In some cases, the I/O controller 1315 may represent a physical connection or port to an external peripheral. In some cases, the I/O controller 1315 may utilize an operating system such as iOS®, ANDROID®, MS-DOS®, MS-WINDOWS®, OS/2®, UNIX®, LINUX®, or another known operating system. In other cases, the I/O controller 1315 may represent or interact with a modem, a keyboard, a mouse, a touchscreen, or a similar device. In some cases, the I/O controller 1315 may be implemented as part of a processor. In some cases, a user may interact with the device 1305 via the I/O controller 1315 or via hardware components controlled by the I/O controller 1315.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM and ROM. The memory 1330 may store computer-readable, computer-executable code 1335 including instructions that, when executed, cause the processor to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting RO and PO configuration in 2-step RACH with UL repetitions).

Based on jointly scheduling ROs and POs, a processor of 1340 of UE 115 may efficiently determine the transmission schedules of ROs and POs without overlapping resources. As such, when a scheduling resource is received, the processor may be ready to respond more efficiently through the reduction of a ramp up in processing power.

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

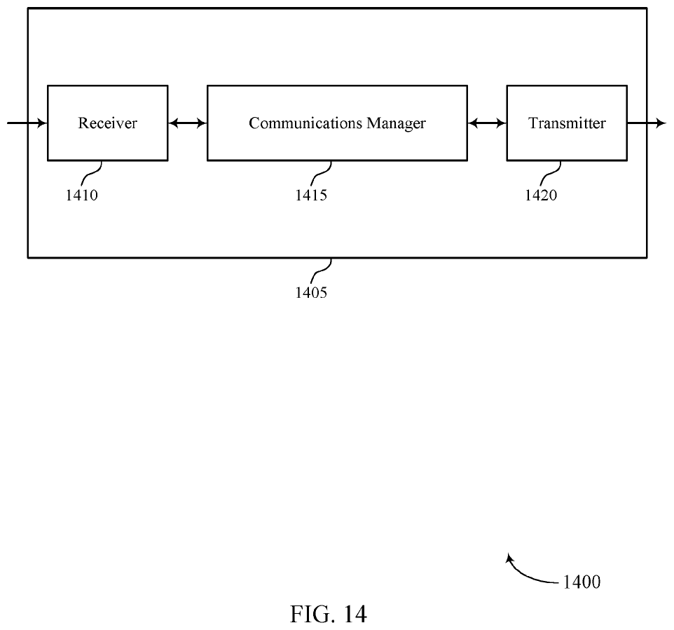

FIG. 14 shows a block diagram 1400 of a device 1405 in accordance with aspects of the present disclosure. The device 1405 may be an example of aspects of a base station 105 as described herein. The device 1405 may include a receiver 1410, a communications manager 1415, and a transmitter 1420. The device 1405 may also include a processor. Each of these components may be in communication with one another (e.g., via one or more buses).

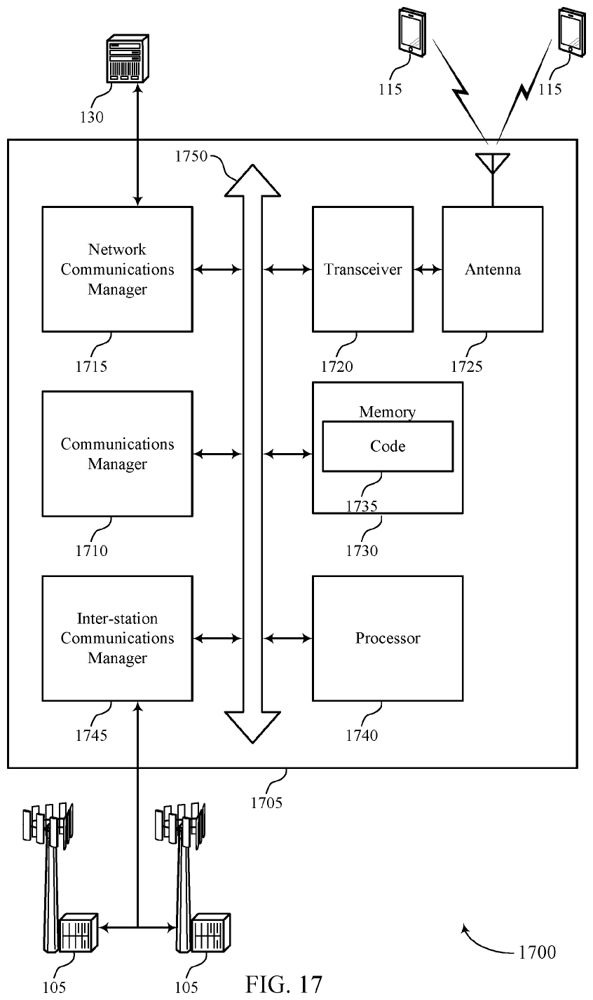

The receiver 1410 may receive information such as packets, user data, or control information associated with various information channels (e.g., control channels, data channels, and information related to RO and PO configuration in 2-step RACH with UL repetitions, etc.). Information may be passed on to other components of the device 1405. The receiver 1410 may be an example of aspects of the transceiver 1720 described with reference to FIG. 17. The receiver 1410 may utilize a single antenna or a set of antennas.

The communications manager 1415 may transmit a message configuring a resource allocation for a first message of a two message random access channel procedure that indicates at least a first random access occasion (RO), receive, based on the message, a first random access preamble of the first message within the first RO, and receive a repetition of a first PUSCH data of the first message corresponding to the first RO in each uplink transmission time interval for a defined number of uplink transmission time intervals that occur after the first RO. The communications manager 1415 may be an example of aspects of the communications manager 1710 described herein.

The communications manager 1415, or its sub-components, may be implemented in hardware, code (e.g., software or firmware) executed by a processor, or any combination thereof. If implemented in code executed by a processor, the functions of the communications manager 1415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1415, or its sub-components, may be physically located at various positions, including being distributed such that portions of functions are implemented at different physical locations by one or more physical components. In some examples, the communications manager 1415, or its sub-components, may be a separate and distinct component in accordance with various aspects of the present disclosure. In some examples, the communications manager 1415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1420 may transmit signals generated by other components of the device 1405. In some examples, the transmitter 1420 may be collocated with a receiver 1410 in a transceiver module. For example, the transmitter 1420 may be an example of aspects of the transceiver 1720 described with reference to FIG. 17. The transmitter 1420 may utilize a single antenna or a set of antennas.

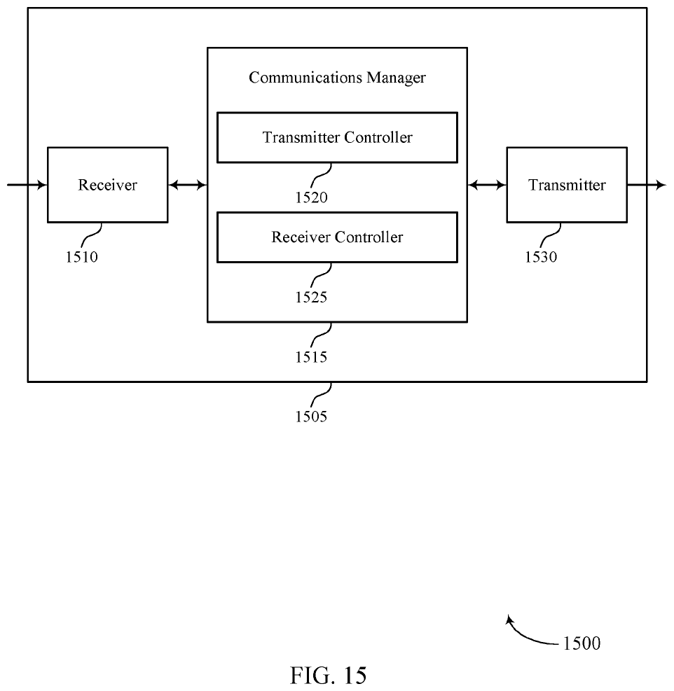

FIG. 15 shows a block diagram 1500 of a device 1505 in accordance with aspects of the present disclosure. The device 1505 may be an example of aspects of a device 1405, or a base station 105 as described herein. The device 1505 may include a receiver 1510, a communications manager 1515, and a transmitter 1530. The device 1505 may also include a processor. Each of these components may be in communication with one another (e.g., via one or more buses).

The receiver 1510 may receive information such as packets, user data, or control information associated with various information channels (e.g., control channels, data channels, and information related to RO and PO configuration in 2-step RACH with UL repetitions, etc.). Information may be passed on to other components of the device 1505. The receiver 1510 may be an example of aspects of the transceiver 1720 described with reference to FIG. 17. The receiver 1510 may utilize a single antenna or a set of antennas.

The communications manager 1515 may be an example of aspects of the communications manager 1415 as described herein. The communications manager 1515 may include a transmitter controller 1520 and a receiver controller 1525. The communications manager 1515 may be an example of aspects of the communications manager 1710 described herein.

The transmitter controller 1520 may transmit a message configuring a resource allocation for a first message of a two message random access channel procedure that indicates at least a first random access occasion (RO).

The receiver controller 1525 may receive, based on the message, a first random access preamble of the first message within the first RO and receive a repetition of a first PUSCH data of the first message corresponding to the first RO in each uplink transmission time interval for a defined number of uplink transmission time intervals that occur after the first RO.

The transmitter 1530 may transmit signals generated by other components of the device 1505. In some examples, the transmitter 1530 may be collocated with a receiver 1510 in a transceiver module. For example, the transmitter 1530 may be an example of aspects of the transceiver 1720 described with reference to FIG. 17. The transmitter 1530 may utilize a single antenna or a set of antennas.

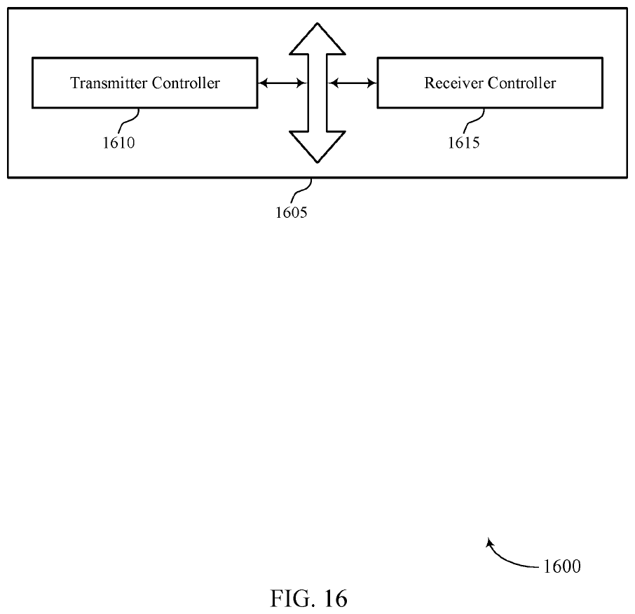

FIG. 16 shows a block diagram 1600 of a communications manager 1605 in accordance with aspects of the present disclosure. The communications manager 1605 may be an example of aspects of a communications manager 1415, a communications manager 1515, or a communications manager 1710 described herein. The communications manager 1605 may include a transmitter controller 1610 and a receiver controller 1615. Each of these modules may communicate, directly or indirectly, with one another (e.g., via one or more buses).

The transmitter controller 1610 may transmit a message configuring a resource allocation for a first message of a two message random access channel procedure that indicates at least a first random access occasion (RO).

In some examples, the transmitter controller 1610 may transmit a second message to establish a wireless communications connection with a user equipment, where the first message is a message A of the two message RACH procedure and the second message is a message B of the two message RACH procedure.

The receiver controller 1615 may receive, based on the message, a first random access preamble of the first message within the first RO.

In some examples, the receiver controller 1615 may receive a repetition of a first PUSCH data of the first message corresponding to the first RO in each uplink transmission time interval for a defined number of uplink transmission time intervals that occur after the first RO.

In some examples, the receiver controller 1615 may receive each repetition of the first PUSCH data for the defined number of uplink transmission time intervals that are consecutive uplink transmission time intervals.

In some examples, the receiver controller 1615 may receive each repetition of the first PUSCH data within a same frequency resource.

In some examples, the receiver controller 1615 may receive a respective repetition of the first PUSCH data in accordance with a frequency hopping pattern.

In some examples, the receiver controller 1615 may receive each repetition of the first PUSCH data with one or more intervening downlink transmission time intervals, special subframe transmission time intervals, or both.

In some examples, the receiver controller 1615 may receive a first repetition of the first PUSCH data at a frequency offset relative to a second repetition of the first PUSCH data based on a second RO and the first repetition being scheduled within a same uplink transmission time interval and having at least partially overlapping frequency resources.

In some examples, the receiver controller 1615 may receive a first repetition of the first PUSCH data in an uplink transmission interval immediately following a last scheduled repetition of the first PUSCH data corresponding to the first RO based on a second RO and the first repetition being scheduled within a same uplink transmission time interval and having at least partially overlapping frequency resources.

In some examples, the receiver controller 1615 may receive a first repetition of the first PUSCH data at a frequency offset relative to a repetition of a second PUSCH data corresponding to a second RO based on the first RO having a lower priority than the second RO; or.

In some examples, the receiver controller 1615 may receive the repetition of the second PUSCH data corresponding to the second RO at a frequency offset relative to the first repetition of the first PUSCH data based on the second RO having a lower priority than the first RO.

In some examples, the receiver controller 1615 may receive a first repetition of the first PUSCH data in an uplink transmission interval immediately following a last scheduled repetition of the first PUSCH data corresponding to the first RO based on the first RO having a lower priority than a second RO; or.

In some examples, the receiver controller 1615 may receive a repetition of a second PUSCH data corresponding to the second RO in an uplink transmission interval immediately following a last scheduled repetition of the second PUSCH data corresponding to the second RO based on the second RO having a lower priority than the first RO.

In some examples, the receiver controller 1615 may receive the first repetition of the first PUSCH data within a same frequency resource as each first PUSCH data based on the first RO having a lower priority than the second RO; or.

In some examples, the receiver controller 1615 may receive the repetition of the second PUSCH data within a same frequency resource as each second PUSCH data based on the second RO having a lower priority than the first RO.

In some examples, the receiver controller 1615 may receive each repetition of the first PUSCH data at a frequency offset relative to each repetition of a second PUSCH data corresponding to a second RO based on the first RO having a lower priority than the second RO; or.

In some examples, the receiver controller 1615 may receive each repetition of the second PUSCH data corresponding to the second RO at a frequency offset relative to each repetition of the first PUSCH data based on the second RO having a lower priority than the first RO.

In some examples, the receiver controller 1615 may receive each repetition of the first PUSCH data in a set of uplink transmission intervals immediately following a last scheduled repetition of a second PUSCH data corresponding to a second RO based on the first RO having a lower priority than the second RO; or.

In some examples, the receiver controller 1615 may receive each repetition of the second PUSCH data corresponding to the second RO in a set of uplink transmission intervals immediately following a last scheduled repetition of the first PUSCH data corresponding to the first RO based on the second RO having a lower priority than the first RO.

In some examples, the receiver controller 1615 may receive in an alternating manner, each repetition of the first PUSCH data followed by each repetition of a second PUSCH data corresponding to a second RO based on the first RO having a higher priority than the second RO; or.

In some examples, the receiver controller 1615 may receive in an alternating manner, each repetition of the second PUSCH data followed by each repetition of the first PUSCH data based on the second RO having a higher priority than the first RO.

FIG. 17 shows a diagram of a system 1700 including a device 1705 in accordance with aspects of the present disclosure. The device 1705 may be an example of or include the components of device 1405, device 1505, or a base station 105 as described herein. The device 1705 may include components for bi-directional voice and data communications including components for transmitting and receiving communications, including a communications manager 1710, a network communications manager 1715, a transceiver 1720, an antenna 1725, memory 1730, a processor 1740, and an inter-station communications manager 1745. These components may be in electronic communication via one or more buses (e.g., bus 1750).

The communications manager 1710 may transmit a message configuring a resource allocation for a first message of a two message random access channel procedure that indicates at least a first random access occasion (RO), receive, based on the message, a first random access preamble of the first message within the first RO, and receive a repetition of a first PUSCH data of the first message corresponding to the first RO in each uplink transmission time interval for a defined number of uplink transmission time intervals that occur after the first RO.

The network communications manager 1715 may manage communications with the core network (e.g., via one or more wired backhaul links). For example, the network communications manager 1715 may manage the transfer of data communications for client devices, such as one or more UEs 115.

The transceiver 1720 may communicate bi-directionally, via one or more antennas, wired, or wireless links as described above. For example, the transceiver 1720 may represent a wireless transceiver and may communicate bi-directionally with another wireless transceiver. The transceiver 1720 may also include a modem to modulate the packets and provide the modulated packets to the antennas for transmission, and to demodulate packets received from the antennas.

In some cases, the wireless device may include a single antenna 1725. However, in some cases the device may have more than one antenna 1725, which may be capable of concurrently transmitting or receiving multiple wireless transmissions.

The memory 1730 may include RAM, ROM, or a combination thereof. The memory 1730 may store computer-readable code 1735 including instructions that, when executed by a processor (e.g., the processor 1740) cause the device to perform various functions described herein. In some cases, the memory 1730 may contain, among other things, a BIOS which may control basic hardware or software operation such as the interaction with peripheral components or devices.

The processor 1740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some cases, a memory controller may be integrated into processor 1740. The processor 1740 may be configured to execute computer-readable instructions stored in a memory (e.g., the memory 1730) to cause the device 1705 to perform various functions (e.g., functions or tasks supporting RO and PO configuration in 2-step RACH with UL repetitions).

The inter-station communications manager 1745 may manage communications with other base station 105, and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communication network technology to provide communication between base stations 105.

The code 1735 may include instructions to implement aspects of the present disclosure, including instructions to support wireless communications. The code 1735 may be stored in a non-transitory computer-readable medium such as system memory or other type of memory. In some cases, the code 1735 may not be directly executable by the processor 1740 but may cause a computer (e.g., when compiled and executed) to perform functions described herein.

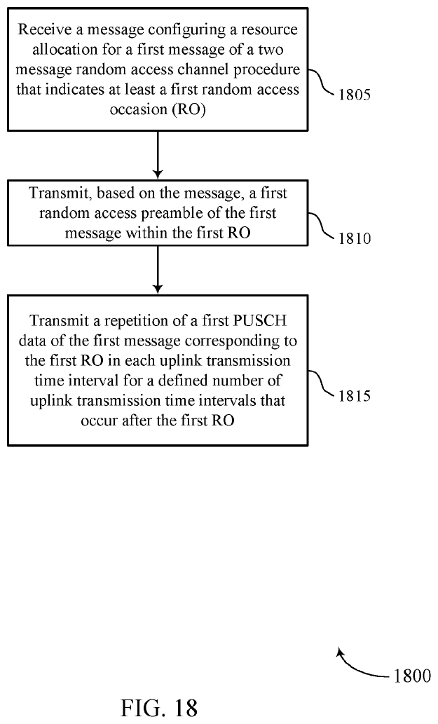

FIG. 18 shows a flowchart illustrating a method 1800 in accordance with aspects of the present disclosure. The operations of method 1800 may be implemented by a UE 115 or its components as described herein. For example, the operations of method 1800 may be performed by a communications manager as described with reference to FIGS. 10 through 13. In some examples, a UE may execute a set of instructions to control the functional elements of the UE to perform the functions described below. Additionally or alternatively, a UE may perform aspects of the functions described below using special-purpose hardware.

At 1805, the UE may receive a message configuring a resource allocation for a first message of a two message random access channel procedure that indicates at least a first random access occasion (RO). The operations of 1805 may be performed according to the methods described herein. In some examples, aspects of the operations of 1805 may be performed by a receiver controller as described with reference to FIGS. 10 through 13.

At 1810, the UE may transmit, based on the message, a first random access preamble of the first message within the first RO. The operations of 1810 may be performed according to the methods described herein. In some examples, aspects of the operations of 1810 may be performed by a transmitter controller as described with reference to FIGS. 10 through 13.

At 1815, the UE may transmit a repetition of a first PUSCH data of the first message corresponding to the first RO in each uplink transmission time interval for a defined number of uplink transmission time intervals that occur after the first RO. The operations of 1815 may be performed according to the methods described herein. In some examples, aspects of the operations of 1815 may be performed by a transmitter controller as described with reference to FIGS. 10 through 13.

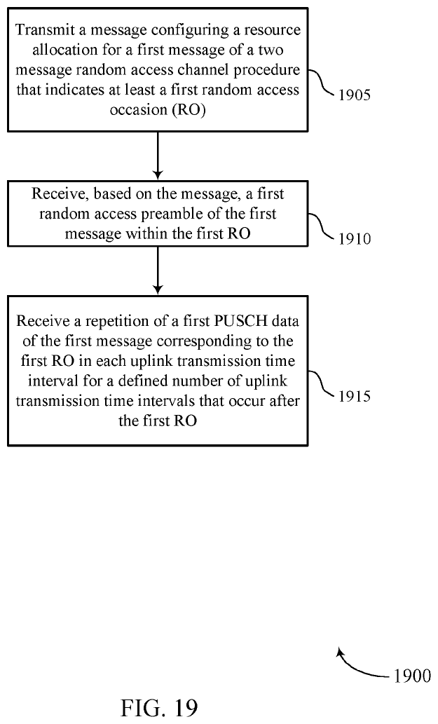

FIG. 19 shows a flowchart illustrating a method 1900 in accordance with aspects of the present disclosure. The operations of method 1900 may be implemented by a base station 105 or its components as described herein. For example, the operations of method 1900 may be performed by a communications manager as described with reference to FIGS. 14 through 17. In some examples, a base station may execute a set of instructions to control the functional elements of the base station to perform the functions described below. Additionally or alternatively, a base station may perform aspects of the functions described below using special-purpose hardware.

At 1905, the base station may transmit a message configuring a resource allocation for a first message of a two message random access channel procedure that indicates at least a first random access occasion (RO). The operations of 1905 may be performed according to the methods described herein. In some examples, aspects of the operations of 1905 may be performed by a transmitter controller as described with reference to FIGS. 14 through 17.

At 1910, the base station may receive, based on the message, a first random access preamble of the first message within the first RO. The operations of 1910 may be performed according to the methods described herein. In some examples, aspects of the operations of 1910 may be performed by a receiver controller as described with reference to FIGS. 14 through 17.

At 1915, the base station may receive a repetition of a first PUSCH data of the first message corresponding to the first RO in each uplink transmission time interval for a defined number of uplink transmission time intervals that occur after the first RO. The operations of 1915 may be performed according to the methods described herein. In some examples, aspects of the operations of 1915 may be performed by a receiver controller as described with reference to FIGS. 14 through 17.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like).

An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication by a user equipment (UE), comprising:
receiving a message configuring a resource allocation for a first message of a two-step random access channel procedure comprising a Message-A transmission and a Message-B reception that indicates at least a first random access occasion (RO) for the Message-A transmission;
transmitting, based at least in part on the message, a first random access preamble of the first message within the first RO; and
transmitting a repetition of a first physical uplink shared channel (PUSCH) data for the Message-A transmission of the first message corresponding to the first RO in each uplink transmission time interval for a defined number of uplink transmission time intervals that occur after the first RO.

2. The method of claim 1, wherein transmitting the repetition of the first PUSCH data in each uplink transmission time interval for the defined number of uplink transmission time intervals comprises:
transmitting each repetition of the first PUSCH data for the defined number of uplink transmission time intervals that are consecutive uplink transmission time intervals.

3. The method of claim 1, wherein transmitting the repetition of the first PUSCH data in each uplink transmission time interval for the defined number of uplink transmission time intervals comprises:
transmitting each repetition of the first PUSCH data within a same frequency resource.

4. The method of claim 1, wherein transmitting the repetition of the first PUSCH data in each uplink transmission time interval for the defined number of uplink transmission time intervals comprises:
transmitting a respective repetition of the first PUSCH data in accordance with a frequency hopping pattern.

5. The method of claim 1, wherein transmitting the repetition of the first PUSCH data in each uplink transmission time interval for the defined number of uplink transmission time intervals comprises:
transmitting each repetition of the first PUSCH data with one or more intervening downlink transmission time intervals, special subframe transmission time intervals, or both.

6. The method of claim 1, wherein transmitting the repetition of the first PUSCH data in each uplink transmission time interval for the defined number of uplink transmission time intervals comprises:
transmitting a first repetition of the first PUSCH data at a frequency offset relative to a second repetition of the first PUSCH data based at least in part on a second RO and the first repetition being scheduled within a same uplink transmission time interval and having at least partially overlapping frequency resources.

7. The method of claim 6, wherein the frequency offset is configured by a requested minimum system information (RMSI) parameter or is preconfigured.

8. The method of claim 1, wherein transmitting the repetition of the first PUSCH data in each uplink transmission time interval for the defined number of uplink transmission time intervals comprises:
transmitting a first repetition of the first PUSCH data in an uplink transmission interval immediately following a last scheduled repetition of the first PUSCH data corresponding to the first random access preamble based at least in part on a second RO and the first repetition being scheduled within a same uplink transmission time interval and having at least partially overlapping frequency resources.

9. The method of claim 8, further comprising:
transmitting each repetition of the first PUSCH data within a same frequency resource.

10. The method of claim 1, wherein transmitting the repetition of the first PUSCH data in each uplink transmission time interval for the defined number of uplink transmission time intervals comprises:
canceling transmission of a first repetition of the first PUSCH data within an uplink transmission time interval based at least in part on a second RO and the first repetition being scheduled within the uplink transmission time interval and having at least partially overlapping frequency resources.

11. The method of claim 1, wherein transmitting the repetition of the first PUSCH data in each uplink transmission time interval for the defined number of uplink transmission time intervals comprises:
transmitting a first repetition of the first PUSCH data at a frequency offset relative to a repetition of a second PUSCH data for the Message-A transmission corresponding to a second RO based at least in part on the first RO having a lower priority than the second RO; or
transmitting the repetition of the second PUSCH data corresponding to the second RO at a frequency offset relative to the first repetition of the first PUSCH data based at least in part on the second RO having a lower priority than the first RO, and
wherein transmitting the first repetition of the first PUSCH data or the repetition of the second PUSCH data is based at least in part on the first repetition of the first PUSCH data and the repetition of the second PUSCH data being scheduled within a same uplink transmission time interval and having at least partially overlapping frequency resources.

12. The method of claim 11, wherein the frequency offset is configured by a requested minimum system information (RMSI) parameter or is preconfigured.

13. The method of claim 1, wherein transmitting the repetition of the first PUSCH data in each uplink transmission time interval for the defined number of uplink transmission time intervals comprises:
transmitting a first repetition of the first PUSCH data in an uplink transmission interval immediately following a last scheduled repetition of the first PUSCH data corresponding to the first RO based at least in part on the first RO having a lower priority than a second RO; or
transmitting a repetition of a second PUSCH data for the Message-A transmission corresponding to the second RO in an uplink transmission interval immediately following a last scheduled repetition of the second PUSCH data corresponding to the second RO based at least in part on the second RO having a lower priority than the first RO; and
wherein transmitting the first repetition of the first PUSCH data or the repetition of the second PUSCH data is based at least in part on the first repetition of the first PUSCH data and the repetition of the second PUSCH data being scheduled within a same uplink transmission time interval and having at least partially overlapping frequency resources.

14. The method of claim 13, further comprising:
transmitting the first repetition of the first PUSCH data within a same frequency resource as each first PUSCH data based at least in part on the first RO having a lower priority than the second RO; or
transmitting the repetition of the second PUSCH data within a same frequency resource as each second PUSCH data based at least in part on the second RO having a lower priority than the first RO.

15. The method of claim 1, wherein transmitting the repetition of the first PUSCH data in each uplink transmission time interval for the defined number of uplink transmission time intervals comprises:
canceling transmission of a first repetition of the first PUSCH data within an uplink transmission time interval based at least in part on the first RO having a lower priority than a second RO; or
canceling transmission of a repetition of a second PUSCH data for the Message-A transmission corresponding to the second RO within an uplink transmission time interval based at least in part on the second RO having a lower priority than the first RO, and
wherein canceling transmission of the first repetition of the first PUSCH data or the repetition of the second PUSCH data is based at least in part on the first repetition of the first PUSCH data and the repetition of the second PUSCH data being scheduled within a same uplink transmission time interval and having at least partially overlapping frequency resources.

16. The method of claim 1, wherein transmitting the repetition of the first PUSCH data in each uplink transmission time interval for the defined number of uplink transmission time intervals comprises:
transmitting each repetition of the first PUSCH data at a frequency offset relative to each repetition of a second PUSCH data corresponding to a second RO based at least in part on the first RO having a lower priority than the second RO; or
transmitting each repetition of the second PUSCH data corresponding to the second RO at a frequency offset relative to each repetition of the first PUSCH data based at least in part on the second RO having a lower priority than the first RO,
wherein transmitting each repetition of the first PUSCH data or each repetition of the second PUSCH data is based at least in part on:
the first RO and the second RO being scheduled within a same uplink transmission time interval, or
the first RO and the second RO being time division multiplexed.

17. The method of claim 16, wherein the frequency offset is configured by a requested minimum system information (RMSI) parameter or is preconfigured.

18. The method of claim 1, wherein transmitting the repetition of the first PUSCH data in each uplink transmission time interval for the defined number of uplink transmission time intervals comprises:
transmitting each repetition of the first PUSCH data in a plurality of uplink transmission intervals immediately following a last scheduled repetition of a second PUSCH data for the Message-A transmission corresponding to a second RO based at least in part on the first RO having a lower priority than the second RO; or
transmitting each repetition of the second PUSCH data corresponding to the second RO in a plurality of uplink transmission intervals immediately following a last scheduled repetition of the first PUSCH data corresponding to the first RO based at least in part on the second RO having a lower priority than the first RO, and
wherein transmitting each repetition of the first PUSCH data or each repetition of the second PUSCH data is based at least in part on the first RO and the second RO being time division multiplexed.

19. The method of claim 1, wherein transmitting the repetition of the first PUSCH data in each uplink transmission time interval for the defined number of uplink transmission time intervals comprises:
transmitting in an alternating manner, each repetition of the first PUSCH data followed by each repetition of a second PUSCH data for the Message-A transmission corresponding to a second RO based at least in part on the first RO having a higher priority than the second RO; or
transmitting in an alternating manner, each repetition of the second PUSCH data followed by each repetition of the first PUSCH data based at least in part on the second RO having a higher priority than the first RO, and
wherein transmitting each repetition of the first PUSCH data or each repetition of the second PUSCH data is based at least in part on the first RO and the second RO being time division multiplexed.

20. The method of claim 1, wherein a mapping ratio for each repetition of the first PUSCH data is based on a ratio between a number of valid Physical Uplink Shared Channel (PUSCH) resource unit sets and a number of valid random access preambles.

21. The method of claim 1, wherein the UE is a New Radio Light UE comprising a lower complexity than other NR UEs.

22. The method of claim 1, wherein the repetition of the first PUSCH data is a default UE capability for New Radio Light UEs.

23. A method for wireless communication by a base station, comprising:
transmitting a message configuring a resource allocation for a first message of a two-step random access channel procedure comprising a Message-A reception and a Message-B transmission that indicates at least a first random access occasion (RO) for the Message-A reception;
receiving, based at least in part on the message, a first random access preamble of the first message within the first RO; and
receiving a repetition of a first physical uplink shared channel (PUSCH) data for the Message-A reception of the first message corresponding to the first RO in each uplink transmission time interval for a defined number of uplink transmission time intervals that occur after the first RO.

24. The method of claim 23, wherein receiving the repetition of the first PUSCH data in each uplink transmission time interval for the defined number of uplink transmission time intervals comprises:
receiving each repetition of the first PUSCH data for the defined number of uplink transmission time intervals that are consecutive uplink transmission time intervals.

25. The method of claim 23, wherein receiving the repetition of the first PUSCH data in each uplink transmission time interval for the defined number of uplink transmission time intervals comprises:
receiving each repetition of the first PUSCH data within a same frequency resource.

26. The method of claim 23, wherein receiving the repetition of the first PUSCH data in each uplink transmission time interval for the defined number of uplink transmission time intervals comprises:
receiving a respective repetition of the first PUSCH data in accordance with a frequency hopping pattern.

27. The method of claim 23, wherein receiving the repetition of the first PUSCH data in each uplink transmission time interval for the defined number of uplink transmission time intervals comprises:
receiving each repetition of the first PUSCH data with one or more intervening downlink transmission time intervals, special subframe transmission time intervals, or both.

28. The method of claim 23, wherein receiving the repetition of the first PUSCH data in each uplink transmission time interval for the defined number of uplink transmission time intervals comprises:
receiving a first repetition of the first PUSCH data at a frequency offset relative to a second repetition of the first PUSCH data based at least in part on a second RO and the first repetition being scheduled within a same uplink transmission time interval and having at least partially overlapping frequency resources.

29. The method of claim 28, wherein the frequency offset is configured by a requested minimum system information (RMSI) parameter or is preconfigured.

30. The method of claim 23, wherein receiving the repetition of the first PUSCH data in each uplink transmission time interval for the defined number of uplink transmission time intervals comprises:
receiving a first repetition of the first PUSCH data in an uplink transmission interval immediately following a last scheduled repetition of the first PUSCH data corresponding to the first RO based at least in part on a second RO and the first repetition being scheduled within a same uplink transmission time interval and having at least partially overlapping frequency resources.

31. The method of claim 30, further comprising:
receiving each repetition of the first PUSCH data within a same frequency resource.

32. The method of claim 23, wherein receiving the repetition of the first PUSCH data in each uplink transmission time interval for the defined number of uplink transmission time intervals comprises:
receiving a first repetition of the first PUSCH data at a frequency offset relative to a repetition of a second PUSCH data for the Message-A reception corresponding to a second RO based at least in part on the first RO having a lower priority than the second RO; or
receiving the repetition of the second PUSCH data corresponding to the second RO at a frequency offset relative to the first repetition of the first PUSCH data based at least in part on the second RO having a lower priority than the first RO, and
wherein receiving the first repetition of the first PUSCH data or the repetition of the second PUSCH data is based at least in part on the first repetition of the first PUSCH data and the repetition of the second PUSCH data being scheduled within a same uplink transmission time interval and having at least partially overlapping frequency resources.

33-41. (canceled)

42. An apparatus for wireless communication by a user equipment (UE), comprising:
a processor,
memory coupled with the processor; and
instructions stored in the memory and executable by the processor to cause the apparatus to:
receive a message configuring a resource allocation for a first message of a two-step random access channel procedure comprising a Message-A transmission and a Message-B reception that indicates at least a first random access occasion (RO) for the Message-A transmission;
transmit, based at least in part on the message, a first random access preamble of the first message within the first RO; and
transmit a repetition of a first physical uplink shared channel (PUSCH) data for the Message-A transmission of the first message corresponding to the first RO in each uplink transmission time interval for a defined number of uplink transmission time intervals that occur after the first RO.

43-63. (canceled)

64. An apparatus for wireless communication by a base station, comprising:
a processor,
memory coupled with the processor; and
instructions stored in the memory and executable by the processor to cause the apparatus to:
transmit a message configuring a resource allocation for a first message of a two-step random access channel procedure comprising a Message-A reception and a Message-B transmission that indicates at least a first random access occasion (RO) for the Message-A reception;
receive, based at least in part on the message, a first random access preamble of the first message within the first RO; and
receive a repetition of a first physical uplink shared channel (PUSCH) data for the Message-A reception of the first message corresponding to the first RO in each uplink transmission time interval for a defined number of uplink transmission time intervals that occur after the first RO.

65-82. (canceled)

83. An apparatus for wireless communication by a user equipment (UE), comprising:
means for receiving a message configuring a resource allocation for a first message of a two-step random access channel procedure comprising a Message-A transmission and a Message-B reception that indicates at least a first random access occasion (RO) for the Message-A transmission;
means for transmitting, based at least in part on the message, a first random access preamble of the first message within the first RO; and
means for transmitting a repetition of a first physical uplink shared channel (PUSCH) data for the Message-A transmission of the first message corresponding to the first RO in each uplink transmission time interval for a defined number of uplink transmission time intervals that occur after the first RO.

84-86. (canceled)
